(19) United States
(12) Patent Application Publication
(10) Pub. No.: US 2024/0330665 A1
(43) Pub. Date: Oct. 3, 2024

(54) COMMAND PROCESSOR, NEURAL PROCESSING DEVICE AND TASK DESCRIPTOR CONFIGURATION METHOD THEREOF

(71) Applicant: REBELLIONS INC., Seongnam-si (KR)

(72) Inventors: Hongyun Kim, Seongnam-si (KR); Miock Chi, Seongnam-si (KR)

(21) Appl. No.: 18/622,228

(22) Filed: Mar. 29, 2024

(30) Foreign Application Priority Data
Mar. 30, 2023 (KR) 10-2023-0042255

(51) Int. Cl. G06N 3/063

(52) U.S. Cl. CPC G06N 3/063

(57) ABSTRACT

An apparatus comprising neural processors, a command processor, and a shared memory is provided. The command processor, in response to receiving a context start signal indicating a start of a context of a neural network model from a host system, directly accesses a memory in the host system to read neural network model data for the context of the neural network model. The command processor, based on a determination on whether the plurality of task descriptors for the previous context of the neural network model are not allowed to be reused for the plurality of task descriptors for the current context of the neural network model, generates the plurality of task descriptors for the current context of the neural network model.

### CROSS-REFERENCE TO RELATED APPLICATION

This application claims priority under 35 U.S.C. § 119 to Korean Patent Application No. 10-2023-0042255, filed in the Korean Intellectual Property Office on Mar. 30, 2023, the entire contents of which are hereby incorporated by reference.

### TECHNICAL FIELD

The present disclosure relates to a command processor, a neural processing device, and a task descriptor configuration method thereof. Specifically, the present disclosure relates to a command processor with improved efficiency of task descriptor configuration, a neural processing device, and a task descriptor configuration method thereof.

### BACKGROUND

In recent years, artificial intelligence (AI) has been discussed as the most promising technology worldwide as a core technology of the fourth Industrial Revolution. The biggest challenge of artificial intelligence would be computing performance. For the artificial intelligence that realizes human learning, reasoning, perception, and performance of natural language, the speed of processing big data is the key factor.

In the early days of the artificial intelligence learning, the central processing unit (CPU) or graphics processing unit (GPU) of related computers are used for deep learning and inference, but there is a limit to use them in the deep learning and inference with high workload, and the neural processing unit (NPU) that is structurally specialized for deep learning is in the spotlight.

The neural network processing device includes a plurality of neural processors that perform deep learning works and computations, and a command processor that configures information related to the task into a task descriptor (command control packet) and distributes it to the neural processing device.

With the increasing number of neural processors and increasing complexity of their configurations, the functions and roles of the command processor that controls the neural processors is more emphasized, and in particular, there is an increasing emphasis on the ways for the command processor to efficiently configure and distribute the task descriptors.

### SUMMARY

An object of the present disclosure is to provide a command processor with improved efficiency of task descriptor configuration.

Another object of the present disclosure is to provide a neural processing device with improved efficiency of task descriptor configuration.

Still another object of the present disclosure is to provide a task descriptor configuration method of a neural processing device with improved efficiency of task descriptor configuration.

The objects of the present disclosure are not limited to the objects described above, and other objects and advantages of the present disclosure that are not described can be understood by the following description and will be more clearly understood by the examples of the present disclosure. In some embodiments, it will be readily apparent that the objects and advantages of the present disclosure can be realized by the means and combinations thereof indicated in the claims. According to some examples, a command processor may include a workload manager that analyzes first workload data received from a host system and configures a first task descriptor, a neural processor interface that transmits the first task descriptor to a neural processor and receives a report related to the first task descriptor, and a memory interface that stores the first task descriptor in a memory, in which the workload manager may analyze second workload data received subsequently to the first workload data from the host system and configure a second task descriptor. in which the workload manager may configure the second task descriptor by reusing at least one piece of control information of the first task descriptor stored in the memory.

In some embodiments, the second workload data may include at least one piece of shared information with the first workload data, and the workload manager may identify the shared information, call control information of the first task descriptor corresponding to the identified shared information from the memory, and configure the second task descriptor.

In some embodiments, the first workload data may include a plurality of context objects for performing a first context, the second workload data may include a plurality of context objects for performing a second context, and the shared information may correspond to a context object included in both the first workload data and the second workload data.

In some embodiments, the first workload data and the second workload data may share, as the shared information, an operation code and at least one piece of variable information according to the operation code.

In some embodiments, the workload manager may include a first reuse checker that identifies the shared information between the first workload data and the second workload data, a command manager that determines a command dependency of the first workload data to sequentially transmit one or more first commands, and determines a command dependency of the second workload data to sequentially transmit one or more second commands, and a CP task manager that generates the first task descriptor based on the one or more first commands, and generates the second task descriptor based on the one or more second commands.

In some embodiments, the CP task manager may include a command staging buffer that stores the one or more first commands of the first workload data and the one or more second commands of the second workload data, a task generator that generates at least one task from the one or more first commands, generates at least one task from the one or more second commands based on the shared information, and generates call information based on the shared information, and a control packet generator that configures the first task descriptor based on the at least one task generated from the one or more first commands, and configures the second task descriptor based on at least one of the at least one task generated from the one or more second commands and the control information of the first task descriptor corresponding to the call information,

In some embodiments, the memory may store the first workload data for comparison with the second workload data.

In some embodiments, the task generator may include a second reuse checker that generates at least one task corresponding to the one or more second commands, while excluding a task corresponding to the shared information, and generates the call information corresponding to information on a task not generated from the one or more second commands, and the control packet generator may configure the second task descriptor based on the task generated by the task generator, in which the control packet generator may read, from the memory, the at least one piece of control information of the first task descriptor based on the call information provided from the second reuse checker, and configure the second task descriptor by reusing the read control information.

In some embodiments, types of the one or more first commands and the one or more second commands may include a DMA type for accessing the memory and a compute type for computational work, and the second reuse checker may configure the call information for each of the types of the commands.

In some embodiments, the CP task manager may include a DMA queue that receives a task of the DMA type from the task generator, and a neural processor queue that receives a task of the compute type from the task generator.

A neural processing device according to some examples of the present disclosure may include at least one neural processor, a memory utilized by the at least one neural processor, and a command processor that analyzes first workload data received from a host system and configures a first task descriptor, in which the command processor may transmit the first task descriptor to the at least one neural processor and store the first task descriptor in the memory, and the command processor may analyze second workload data received subsequently to the first workload data from the host system and configure a second task descriptor, in which the workload manager may configure the second task descriptor by using at least one piece of control information of the first task descriptor stored in the memory.

In some embodiments, the second workload data may include at least one piece of shared information with the first workload data, and the command processor may call, from the memory, control information of the first task descriptor corresponding to the shared information, and configure the second task descriptor.

In some embodiments, the first workload data may include a plurality of context objects for performing a first context, the second workload data may include a plurality of context objects for performing a second context, and the shared information may correspond to a context object included in both the first workload data and the second workload data.

In some embodiments, the first workload data and the second workload data may share, as the shared information, an operation code and at least one piece of variable information according to the operation code.

In some embodiments, the command processor may include a reuse checker that identifies the shared information between the first workload data and the second workload data.

In some embodiments, the command processor may generate at least one task based on the second workload data, while excluding a task corresponding to the shared information, and the command processor may configure the second task descriptor corresponding to the generated task, in which the command processor may read, from the memory, the at least one piece of control information of the first task descriptor based on the shared information provided from the reuse checker, and configure the second task descriptor by reusing the read control information.

According to some examples, a task descriptor configuration method of a neural processing device may include receiving first workload data from a host system, analyzing the first workload data to generate a first task descriptor, transmitting the first task descriptor to at least one neural processor and storing the first task descriptor in a memory, receiving second workload data from the host system, and configuring the second task descriptor by using the second workload data and at least one piece of control information of the first task descriptor stored in the memory.

In some embodiments, the second workload data may include at least one piece of shared information with the first workload data, and the configuring the second task descriptor may include identifying the shared information between the first workload data and the second workload data, and configuring the second task descriptor based on the shared information.

In some embodiments, the first workload data may include a plurality of context objects for performing a first context, the second workload data may include a plurality of context objects for performing a second context, and the shared information may correspond to a context object included in both the first workload data and the second workload data.

In some embodiments, the configuring the second task descriptor based on the shared information may include generating at least one task based on the second workload data, while excluding a task corresponding to the shared information, and configuring the second task descriptor corresponding to the generated task, in which at least one piece of control information of the first task descriptor may be read from the memory based on the shared information, and the second task descriptor may be configured by reusing the read control information. According to some examples of the present disclosure, the command processor, the neural processing device, and the task descriptor configuration method thereof can store previously-generated task descriptors in the memory and selectively reuse necessary information to configure the subsequent task descriptors, thereby saving unnecessary use of resources associated with configuring a new task descriptor each time, and also assisting configuring and distributing task descriptors more efficiently.

In some embodiments to the effects mentioned above, specific effects of the present disclosure are described below while explaining specific details for carrying out the present disclosure.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a block diagram provided to explain a neural processing system according to some examples of the present disclosure;

FIG. 2 is a block diagram provided to explain the neural processing device of FIG. 1 in detail;

FIG. 3 is a block diagram provided to explain the host system of FIG. 1 in detail;

FIG. 4 is a block diagram provided to explain a neural processing system according to some examples of the present disclosure;

FIG. 5 is a diagram provided to explain data stored by the host processor of FIG. 3 in a host off-chip memory;

FIG. 6 is a diagram provided to explain the first buffer descriptor area of FIG. 5;

FIG. 7 is a diagram provided to explain the command buffer area of FIG. 5;

FIG. 8 is a diagram provided to explain data transmission between a host processor and a neural core SoC;

FIG. 9 is a block diagram provided to explain the neural core SoC of FIG. 2 in detail;

FIG. 10 is a structural diagram provided to explain the global interconnection of FIG. 9 in detail;

FIG. 11 is a block diagram provided to explain the flow of control signals of the neural processing device of FIG. 1;

FIG. 12 is a block diagram provided to explain the command processor of FIG. 11 in detail;

FIG. 13 is a block diagram provided to explain the system manager of FIG. 12 in detail;

FIG. 14 is a block diagram provided to explain the workload manager of FIG. 12 in detail;

FIG. 15 is a block diagram provided to explain the command manager of FIG. 14 in detail;

FIG. 16 is a block diagram provided to explain the CP task manager of FIG. 14 in detail;

FIG. 17 illustrates an example structure of a task descriptor according to some examples of the present disclosure;

FIG. 18 illustrates sequences for configuring a first task descriptor corresponding to first workload data, in the neural processing device according to some examples of the present disclosure;

FIG. 19 is a diagram provided to explain a process of storing a task descriptor in a memory according to some examples of the present disclosure;

FIG. 20 illustrates sequences for configuring a second task descriptor corresponding to second workload data, in the neural processing device according to some examples of the present disclosure;

FIG. 21 is a diagram provided to explain an operation of a reuse checker according to some examples of the present disclosure;

FIG. 22 is a block diagram provided to explain the workload manager according to some examples of the present disclosure;

FIGS. 23 and 24 are diagrams provided to explain an example in which the reuse checker is configured in the CP task manager according to some examples of the present disclosure;

FIG. 24 is a diagram provided to explain an operation of the reuse checker according to some examples of the present disclosure;

FIG. 25 is a diagram provided to explain a process of calling a task descriptor stored in a memory according to some examples of the present disclosure;

FIG. 26 is a block diagram provided to explain the neural processor of FIG. 11 in detail;

FIG. 27 is a diagram provided to explain a hierarchical structure of the neural processing device according to some examples of the present disclosure;

FIG. 28 is a block diagram provided to explain the neural core of FIG. 26 in detail;

FIG. 29 is a block diagram provided to explain the LSU of FIG. 28 in detail;

FIG. 30 is a block diagram provided to explain the processing unit of FIG. 28 in detail;

FIG. 31 is a block diagram provided to explain the L0 memory of FIG. 28 in detail;

FIG. 32 is a block diagram provided to explain the local memory bank of FIG. 31 in detail;

FIG. 33 is a block diagram provided to explain the flow of data and control signals of the neural processing device of FIG. 1;

FIG. 34 is a block diagram provided to explain the relations between the command processor and the task manager of FIG. 33;

FIG. 35 is a block diagram provided to explain in detail the structure of the neural processing system according to some examples of the present disclosure;

FIG. 36 is a diagram provided to explain the hierarchical structure of the command processor and the task managers of the neural processing device according to some embodiments of the present disclosure;

FIG. 37 is a diagram provided to explain the hierarchical structure of the command processor and the task managers of the neural processing device according to some embodiments of the present disclosure;

FIG. 38 is a block diagram provided to explain memory reorganization of the neural processing system of FIG. 1;

FIG. 39 is a block diagram illustrate an example of memory reorganization of the neural processing system of FIG. 1;

FIG. 40 is an enlarged block diagram of the area A in FIG. 38;

FIG. 41 is a diagram provided to explain the first memory bank of FIG. 40 in detail;

FIG. 42 is a block diagram provided to explain the software hierarchy of the neural processing device of FIG. 1;

FIG. 43 is a conceptual diagram provided to explain a deep learning computation performed by the neural processing device of FIG. 1;

FIG. 44 is a conceptual diagram provided to explain the learning and inference operations of the neural network of the neural processing device of FIG. 1;

FIG. 45 is a flowchart provided to explain a task descriptor configuration method of the neural processing device according to some examples of the present disclosure;

FIG. 46 illustrates detailed steps of the second task configuration step in FIG. 45; and

FIG. 47 is a ladder diagram for executing a context of the neural network model according to some examples of the disclosure.

### DETAILED DESCRIPTION

The terms or words used herein should not be construed as limited to their general or dictionary meanings. According to the principle that the inventor may define the concepts of terms or words in order to explain his or her invention in the best way, it should be interpreted with a meaning and concept consistent with the technical idea of the present disclosure. In addition, the examples described herein and the configurations shown in the drawings are merely one example for implementing the present disclosure, and do not completely represent the technical idea of the present disclosure, so it should be understood that there may be various equivalents, modifications, and applicable examples that may replace them at the time of filing this application.

Terms such as first, second, A, B and so on used in this specification and claims may be used in describing a variety of elements, but these elements should not be limited to the expression. The expressions are used only for the purpose of distinguishing one element from another. For example, without departing from the scope of the present disclosure, a first component may be referred to as a second component, and similarly, the second component may also be referred to as the first component. The term “and/or” includes a combination of a plurality of related described items or any of a plurality of related described items.

The terms used herein are merely used to describe specific examples and are not intended to limit the invention. Unless otherwise specified, a singular expression includes a plural expression. It should be understood that terms such as “include” or “have” used herein do not preclude the existence or possibility of addition of features, numbers, steps, operations, components, parts, or combinations thereof described herein. Terms such as “circuit,” or “circuitry” may refer to a circuit on hardware, but may also refer to a circuit on software.

Unless defined otherwise, all expressions used herein, including technical or scientific expressions, have the same meaning as commonly understood by one of ordinary skill in the art to which the present disclosure pertains.

Expressions such as those defined in commonly used dictionaries should be interpreted as having a meaning consistent with the meaning in the context of the relevant art and are to be interpreted as ideal or overly formal in meaning unless explicitly defined in the present application.

In addition, each configuration, process, step, method, or the like included in each example of the present disclosure may be shared within the scope of not being technically contradictory to each other.

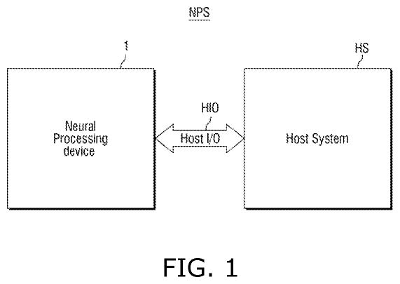

Hereinafter, a neural processing system according to some examples of the present disclosure will be described with reference to FIGS. 1 to 46.

FIG. 1 is a block diagram provided to explain a neural processing system according to some examples of the present disclosure.

Referring to FIG. 1, a neural processing system (NPS) according to some examples of the present disclosure may include a first neural processing device 1, a host system (HS), and a host interface (HIO).

The first neural processing device 1 may be a device that performs computations using an artificial neural network. The first neural processing device 1 may be a device specialized for performing a deep learning computational work, for example. However, aspects are not limited to the above.

The first neural processing device 1 may be a processing device other than a neural processing device. That is, the first neural processing device 1 may be a graphics processing unit (GPU), a central processing unit (CPU), or other types of processing devices. Hereinafter, for convenience of description, the first neural processing device 1 will be explained by referring to a neural processing device.

The host system (HS) may be a system that instructs the first neural processing device 1 to perform a computational work and retrieve the result of the computational work. Compared to the first neural processing device 1, the host system (HS) may be a system that is not specialized for the deep learning computational works. However, aspects are not limited to the above.

The host interface (HIO) may transmit the data and control signals between the first neural processing device 1 and the host system (HS). For example, the host interface (HIO) may transmit commands and data from the host system (HS) to the first neural processing device 1, and the first neural processing device 1 may perform the computational work accordingly. Upon completing the computational work, the first neural processing device 1 may transmit the result to the host system (HS) through an interrupt request. For example, the host interface (HIO) may be PCI Express (PCIe), but is not limited thereto.

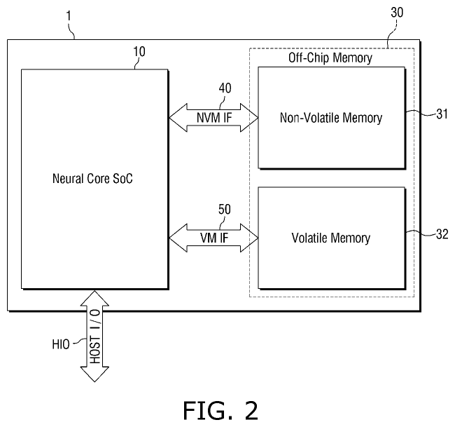

FIG. 2 is a block diagram provided to explain the neural processing device of FIG. 1 in detail.

Referring to FIG. 2, the first neural processing device 1 may include a neural core SoC 10, an off-chip memory 30, a non-volatile memory interface 40, and a volatile memory interface 50.

The neural core SoC 10 may be a System on Chip device. The neural core SoC 10 may be an artificial intelligence computing unit and may be an accelerator. The neural core SoC 10 may be any one of a graphics processing unit (GPU), a field programmable gate array (FPGA), and an application-specific integrated circuit (ASIC), for example. However, aspects are not limited to the above.

The neural core SoC 10 may exchange data with other external computing units through a separate external interface. In addition, the neural core SoC 10 may be connected to a non-volatile memory 31 and a volatile memory 32 through the non-volatile memory interface 40 and the volatile memory interface 50, respectively.

The off-chip memory 30 may be a memory disposed outside a chip of the neural core SoC 10. The off-chip memory 30 may include the non-volatile memory 31 and the volatile memory 32.

The non-volatile memory 31 may be a memory that continuously retains stored information even when there is no power supply. For example, the non-volatile memory 31 may include at least one of a Read-Only Memory (ROM), a Programmable Read-Only Memory (PROM), an Erasable Alterable ROM (EAROM), an Erasable Programmable Read-Only Memory (EPROM), an Electrically Erasable Programmable Read-Only Memory (EEPROM) (e.g., a NAND flash memory, a NOR flash memory), an Ultra-Violet Erasable Programmable Read-Only Memory (UVEPROM), a Ferroelectric Random Access Memory (FeRAM), a Magnetoresistive Random Access Memory (MRAM), a Phase-change Random Access Memory (PRAM), a silicon-oxide-nitride-oxide-silicon (SONOS), a Resistive Random Access Memory (RRAM), a Nanotube Random Access Memory (NRAM), a magnetic computer storage devices such as hard disks, and a magnetic computer storage device (e.g., hard disk, diskette drive, magnetic tape), an optical disk drive, and 3D XPoint memory. However, aspects are not limited to the above.

Unlike the non-volatile memory 31, the volatile memory 32 may be a memory that continuously requires power to maintain stored information. For example, the volatile memory 32 may include at least one of a Dynamic Random Access Memory (DRAM), a Static Random Access Memory (SRAM), a Synchronous Dynamic Random Access Memory (SDRAM), and a Double Data Rate SDRAM (DDR SDRAM). However, aspects are not limited to the above.

For example, the non-volatile memory interface 40 may include at least one of a Parallel Advanced Technology Attachment (PATA), a Small Computer System Interface (SCSI), a Serial Attached SCSI (SAS), a Serial Advanced Technology Attachment (SATA), and a PCI Express (PCIc). However, aspects are not limited to the above.

For example, the volatile memory interface 50 may be at least one of Single Data Rate (SDR), Double Data Rate (DDR), Quad Data Rate (QDR), eXtreme Data Rate (XDR), and Octal Data Rate. However, aspects are not limited to the above.

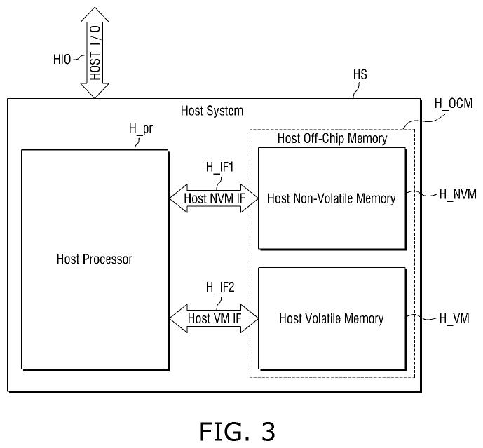

FIG. 3 is a block diagram provided to explain the host system of FIG. 1 in detail.

Referring to FIG. 3, the host system (HS) may include a host processor (H_pr), a host off-chip memory (H_OCM), a host non-volatile memory interface 7400, and a host volatile memory interface 7400.

The host processor (H_pr) may be a controller that controls the system of the first neural processing device 1 and executes the computations of the program. The host processor (H_pr) may be a general-purpose computing unit and may not be efficient to perform parallel simple computations frequently used in deep learning. Accordingly, the neural core SoC 10 may perform computations for deep learning reasoning and training works, thus achieving high efficiency.

The host processor (H_pr) may be connected to the host non-volatile memory (H_NVM) and the host volatile memory (H_VM) through the host non-volatile memory interface (H_IF1) and the host volatile memory interface (H_IF2), respectively.

The host processor (H_pr) may also transmit a task to the neural core SoC 10 through commands. The host processor (H_pr) may be an entity that gives instructions for works, and may be a kind of host that instructs the neural core SoC 10. That is, the neural core SoC 10 may efficiently perform parallel computational works such as deep learning works according to the instructions of the host processor (H_pr).

The host off-chip memory (H_OCM) may be memory placed outside the chip of the host processor (H_pr). The host off-chip memory (H_OCM) may include a host non-volatile memory (H_NVM) and a host volatile memory (H_VM).

The host non-volatile memory (H_NVM) may be a memory that continuously retains stored information even when there is no power supply. For example, the host non-volatile memory (H_NVM) may include at least one of a Read-Only Memory (ROM), a Programmable Read-Only Memory (PROM), an Erasable Alterable ROM (EAROM), an Erasable Programmable Read-Only Memory (EPROM), an Electrically Erasable Programmable Read-Only Memory (EEPROM) (e.g., a NAND flash memory, a NOR flash memory), an Ultra-Violet Erasable Programmable Read-Only Memory (UVEPROM), a Ferroelectric Random Access Memory (FeRAM), a Magnetoresistive Random Access Memory (MRAM), a Phase-change Random Access Memory (PRAM), a silicon-oxide-nitride-oxide-silicon (SONOS), a Resistive Random Access Memory (RRAM), a Nanotube Random Access Memory (NRAM), a magnetic computer storage devices such as hard disks, and a magnetic computer storage device (e.g., hard disk, diskette drive, magnetic tape), an optical disk drive, or 3D XPoint memory. However, aspects are not limited to the above.

Unlike the host non-volatile memory (H_NVM), the host volatile memory (H_VM) may be a memory that continuously requires power in order to maintain stored information. For example, the host non-volatile memory (H_NVM) may include at least one of a Dynamic Random Access Memory (DRAM), a Static Random Access Memory (SRAM), a Synchronous Dynamic Random Access Memory (SDRAM), and a Double Data Rate SDRAM (DDR SDRAM). However, aspects are not limited to the above.

For example, the host non-volatile memory interfaces (H_IF1) may each include at least one of a Parallel Advanced Technology Attachment (PATA), a Small Computer System Interface (SCSI), a Serial Attached SCSI (SAS), a Serial Advanced Technology Attachment (SATA), and a PCI Express (PCIe). However, aspects are not limited to the above.

For example, the host volatile memory interface (H_IF2) may be at least one of Single Data Rate (SDR), Double Data Rate (DDR), Quad Data Rate (QDR), eXtreme Data Rate (XDR), and Octal Data Rate. However, aspects are not limited to the above.

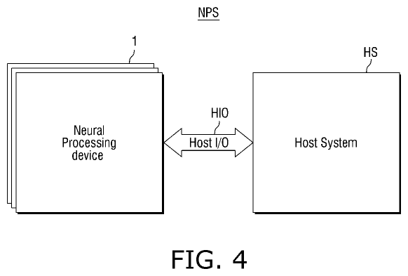

FIG. 4 is a block diagram provided to explain a neural processing system according to some examples of the present disclosure.

Referring to FIG. 4, a plurality of first neural processing devices 1 may be provided. The first neural processing device 1 may be connected to the host system (HS) through the host interface (HIO). While one host interface (HIO) is illustrated in the drawing, aspects are not limited thereto, and the host interface (HIO) may include a plurality of interfaces connecting each of the first neural processing devices 1 and the host system (HS).

The plurality of first neural processing devices 1 may exchange data and signals with one another. The plurality of first neural processing devices 1 may transmit data and signals to one another via separate interfaces rather than the host system (HS). However, aspects are not limited to the above.

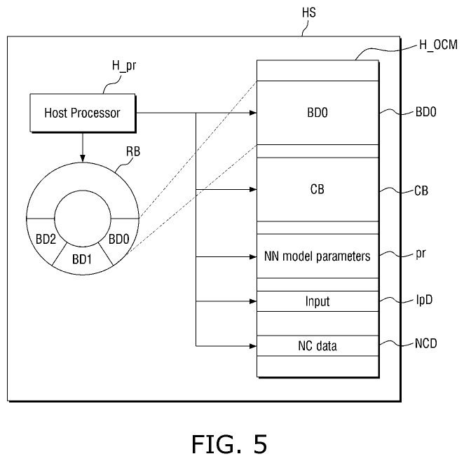

FIG. 5 is a diagram provided to explain data stored by the host processor of FIG. 3 in a host off-chip memory.

Referring to FIG. 5, the host processor (H_pr) may store workload data in a workload data area. The workload data may include at least one of neural network model parameter data, input data, and neural core data for the neural processing device. However, aspects are not limited to the above.

Specifically, the neural network model parameter data may be stored in a parameter area (pr) of the host off-chip memory (H_OCM), and the input data may be stored in an input data area (IpD). Further, the neural core data may be stored in a neural core data area (NCD) of the host off-chip memory (H_OCM). In some embodiments, the neural network model parameter data may comprise weights for each of layers the current context of the neural network model. In some embodiments, the neural core data may contain one or more binary codes using the input data and the parameter data for the current context of the neural network model.

The host processor (H_pr) may generate a buffer descriptor. The buffer descriptor may include details of the command buffer. In some embodiments, the buffer descriptor and the command buffer may be referred to as the primary context descriptor and the second primary context descriptor, respectively. The buffer descriptor may be stored in a ring buffer (RB). The ring buffer (RB) may be formed in the host off-chip memory (H_OCM) and is implemented such that the host system (HS) and the first neural processing device 1 may sequentially store and access each area.

In FIG. 5, for example, first to third buffer descriptors (BD0 to BD2) may be stored in a first buffer descriptor area (BD0), a second buffer descriptor area (BD1), and a third buffer descriptor area (BD2), respectively. However, aspects are not limited to the above. In some embodiments, the number of buffer descriptors and the number of buffer descriptor areas may vary. The ring buffer (RB) may generate the buffer descriptor areas in such a manner that, empty areas in a limited memory area within the ring buffer (RB) are first filled and then the used areas are reused. That is, the ring buffer (RB) has a ring shape in which the first and last elements in the area are connected, thus allowing efficient use of the buffer memory in the limited area.

Further, the host processor (H_pr) may configure a command buffer in a command buffer area (CB) of the host off-chip memory (H_OCM). Through this, the host processor (H_pr) may store all of buffer descriptors, command buffers, and workload data in the host off-chip memory (H_OCM).

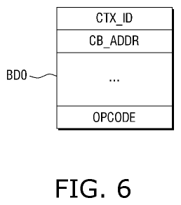

FIG. 6 is a diagram provided to explain the first buffer descriptor area of FIG. 5.

Referring to FIGS. 1 and 6, the first buffer descriptor area (BD0) may include detailed information for the host system (HS) to transmit a work to the first neural processing device 1. For example, the first buffer descriptor area (BD0) may include at least one of a context ID (CTX_ID), a command buffer address (CB_ADDR), and an operation code (OPCODE). However, aspects are not limited to the above.

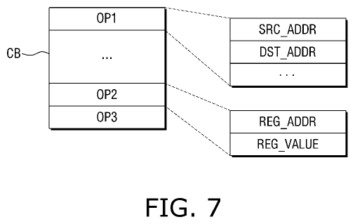

FIG. 7 is a diagram provided to explain the command buffer area of FIG. 5.

Referring to FIG. 7, the command buffer area (CB) may be designated by the address of the command buffer area (CB) of the first buffer descriptor area (BD0). Specifically, there may be a plurality of command buffer areas (CB), and the first buffer descriptor may designate the address of a specific command buffer area (CB) according to workloads.

The command buffer area (CB) may store operations including a first operation (OP1), a second operation (OP2), and a third operation (OP3) for the workloads.

Each operation may include variable information suitable for the features of the operation. For example, the first operation (OP1) may include variable information such as a source address (SRC_ADDR) and a destination address (DST_ADDR).

In some embodiments, the second operation (OP2) and the third operation (OP3) may include information such as a register address (REG_ADDR) and a register value (REG_VALUE), respectively. However, aspects are not limited to the above.

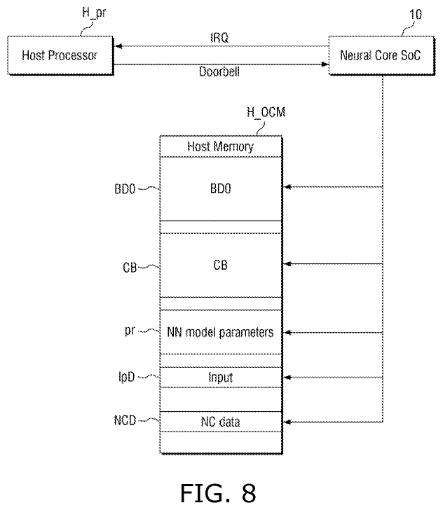

FIG. 8 is a diagram provided to explain data transmission between a host processor and a neural core SoC.

Referring to FIG. 8, the host processor (H_pr) may transmit a doorbell to the neural core SoC 10. The doorbell may be the first one, that is, the first doorbell that may include information of the buffer descriptor area that has to be read by the neural core SoC 10. In some embodiments, a context start signal indicating a start of the current context of the neural network model may be referred to as the doorbell.

The neural core SoC 10 may read and decode the first buffer descriptor area BD0 in the host off-chip memory H_OCM. Accordingly, the neural core SoC 10 may obtain the address of the command buffer area (CB), and read and decode the command buffer area (CB). Because the command buffer area (CB) includes the address information for the parameter area (pr) having the first workload data, the input data area (IpD), and the neural core data area (NCD), the neural core SoC 10 may read the first workload data and perform works accordingly.

The neural core SoC 10 may send an interrupt request (IRQ) to the host processor (H_pr), if the interrupt request (IRQ) to the host processor (H_pr) is required during or after the work.

The host processor (H_pr) may additionally transmit a second doorbell different from the first doorbell to the neural core SoC 10. The second doorbell may include information that it is not necessary to load the data of the first buffer descriptor area (BD0) and the command buffer area (CB). Accordingly, the neural core SoC 10 may directly perform the next step without accessing the first buffer descriptor area (BD0) and the command buffer area (CB).

The second doorbell may include information on a change from the first doorbell. For example, the second doorbell may include an address of the input data area (IpD). The deep learning computations often involve repeating the same computational work by changing only the input data. In this case, the host processor (H_pr) indicates, in the second doorbell, only the input data that is changed from the first doorbell, so that the neural core SoC 10 reads only the input data without unnecessarily accessing the buffer descriptor area and the command buffer area (CB) again. As a result, it is possible to minimize the data transmission between the host system (HS) and the neural core SoC 10 and maximize efficiency.

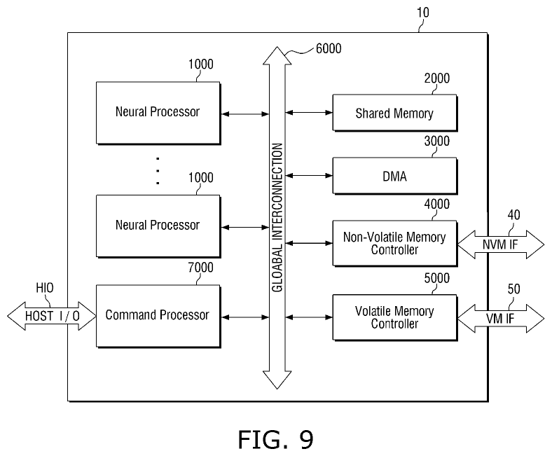

FIG. 9 is a block diagram provided to explain the neural core SoC of FIG. 2 in detail.

Referring to FIGS. 2 and 9, the neural core SoC 10 may include at least one neural processor 1000, a shared memory 2000, a Direct Memory Access (DMA) 3000, a non-volatile memory controller 4000, a volatile memory controller 5000, a command processor 7000, and a global interconnection 6000. The command processor 7000 may also be called a command processor circuit, but will be uniformly referred to as the command processor for convenience of description. Additionally, the command processor 7000 may be implemented as a circuit (or circuitry).

In software aspect, the command processor 7000 may be implemented on the off-chip memory 30 of FIG. 2, or particularly, on the volatile memory 32. However, aspects are not limited to the above, and it may be implemented as separate hardware. Further, part of the command processor 7000 may be implemented in software, and another part may be implemented in hardware. The part implemented in hardware may increase the computing speed of the command processor 7000.

The neural processor 1000 may be a computing unit that directly performs computational works. If there are a plurality of neural processors 1000, the computational works may be allocated to each of the neural processors 1000. Each of the neural processors 1000 may be connected to each other through the global interconnection 6000.

The shared memory 2000 may be a memory shared by several neural processors 1000. The shared memory 2000 may store data of each neural processor 1000. In addition, the shared memory 2000 may receive data from the off-chip memory 30, temporarily store the data, and transmit the data to each neural processor 1000. Conversely, the shared memory 2000 may receive data from the neural processor 1000, temporarily store the data, and transmit the data to the off-chip memory 30 of FIG. 2.

The shared memory 2000 may require a relatively fast memory. Accordingly, the shared memory 2000 may include SRAM, for example. However, aspects are not limited to the above. That is, the shared memory 2000 may include DRAM.

The shared memory 2000 may be a memory corresponding to an SoC level, that is, to level 2 (L2). Accordingly, the shared memory 2000 may be defined as the L2 shared memory.

The DMA 3000 may directly control data movement without requiring the host processor (H_pr) or the neural processor 1000 to control input/output of data. Accordingly, the DMA 3000 may control the data movement between memories to minimize the number of interrupts of the host processor (H_pr) or the neural processor 1000.

The DMA 3000 may control the movement of data between the shared memory 2000 and the off-chip memory 30. The non-volatile memory controller 4000 and the volatile memory controller 5000 may perform the movement of data through the authority of the DMA 3000.

The non-volatile memory controller 4000 may control read or write work for the non-volatile memory 31. The non-volatile memory controller 4000 may control the non-volatile memory 31 through the non-volatile memory interface 40.

The volatile memory controller 5000 may control the read or write work for the volatile memory 32. In addition, the volatile memory controller 5000 may perform a refresh work for the volatile memory 32. The volatile memory controller 5000 may control the volatile memory 32 through the volatile memory interface 50.

The command processor 7000 may be connected to the host interface (HIO). The command processor 7000 may receive a control signal from the host processor (H_pr) through the host interface (HIO). The command processor 7000 may generate a task through the control signal received from the host processor (H_pr) and transmit the generated task to each neural processor 1000. In addition, the command processor 7000 may receive a task completion report from each neural processor 1000.

The global interconnection 6000 connects at least one neural processor 1000, the shared memory 2000, the DMA 3000, the non-volatile memory controller 4000, the command processor 7000, and the volatile memory controller 5000 to one another. Additionally, the external interface may also be connected to the global interconnection 6000. The global interconnection 6000 may be a path through which data moves between at least one neural processor 1000, the shared memory 2000, the DMA 3000, the non-volatile memory controller 4000, the volatile memory controller 5000, the command processor 7000, and the external interface.

The global interconnection 6000 may transmit not only the data, but also control signals and signals for synchronization. In the neural processing device according to some examples of the disclosure, each neural processor 1000 may directly transmit and receive the synchronization signal. Accordingly, latency due to transmission of the synchronization signal generated by the command processor 7000 may be minimized.

That is, if there are a plurality of neural processors 1000, there may be a dependency of individual works in which the work of one neural processor 1000 must be completed before the next neural processor 1000 may start a new work. The end and start of these individual works may be confirmed through the synchronization signals, but according to the existing technology, the command processor 7000 or the host, that is, the host processor (H_pr) is in full charge of receiving the synchronization signal and instructing the start of a new work.

However, if the number of neural processors 1000 increases and the dependency of the works is designed more complexly, the number of synchronization signals will increase exponentially, and the latency according to each synchronization signal may significantly reduce the efficiency of the works.

Therefore, in the neural processing device according to some examples of the present disclosure, instead of the command processor 7000, each neural processor 1000 may directly transmit part of the synchronization signals to the other neural processors 1000 according to the dependency of the work. In this case, compared to the way of managing by the command processor 7000, multiple neural processors 1000 may perform synchronization works in parallel, thereby minimizing latency due to synchronization.

In addition, the command processor 7000 also performs work scheduling of the neural processors 1000 according to the work dependency, and the overhead of such scheduling may increase significantly as the number of neural processors 1000 increases. Accordingly, in the neural processing device according to some examples of the present disclosure, the scheduling work is partially performed by the individual neural processor 1000, which may reduce the scheduling burden and thus improve the performance of the device.

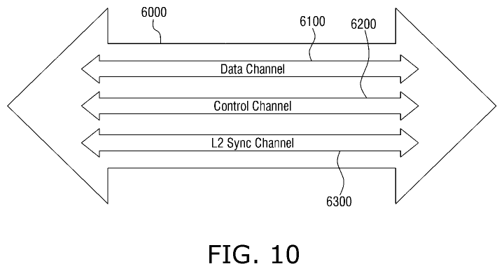

FIG. 10 is a structural diagram provided to explain the global interconnection of FIG. 9 in detail.

Referring to FIG. 4, the global interconnection 6000 may include a data channel 6100, a control channel 6200, and an L2 sync channel 6300.

The data channel 6100 may be a private channel for transmitting data. Through the data channel 6100, at least one neural processor 1000, the shared memory 2000, the DMA 3000, the non-volatile memory controller 4000, the volatile memory controller 5000, and the external interface may exchange data with one another.

The control channel 6200 may be a private channel for transmitting control signals. Through the control channel 6200, at least one neural processor 1000, the shared memory 2000, the DMA 3000, the non-volatile memory controller 4000, the volatile memory controller 5000, the command processor 7000, and the external interface may exchange control signals with one another. In particular, the command processor 7000 may transmit various control signals to each of the neural processors 1000.

The L2 sync channel 6300 may be a private channel for transmitting synchronization signals. Through the L2 sync channel 6300, at least one neural processor 1000, the shared memory 2000, the DMA 3000, the non-volatile memory controller 4000, the volatile memory controller 5000, the command processor 7000, and the external interface may exchange synchronization signals with one another.

The L2 sync channel 6300 may be set as a private channel inside the global interconnection 6000 so as to allow fast transmission of the synchronization signals without overlapping with other channels. Accordingly, the neural processing device may smoothly perform synchronization using the existing global interconnection 6000 without requiring new wiring work.

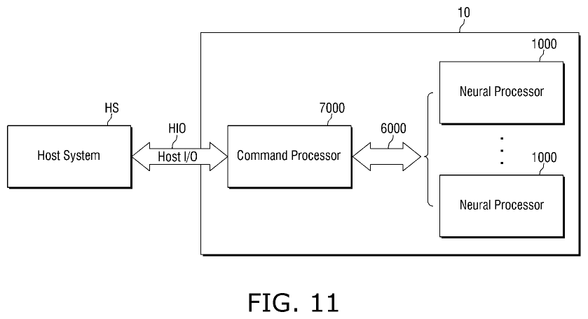

FIG. 11 is a block diagram provided to explain the flow of control signals of the neural processing device of FIG. 1.

Referring to FIG. 11, the host processor (H_pr) may transmit the control signals to the command processor 7000 through the host interface (HIO). The control signal may be a signal to instruct to perform each operation including a computational work, a data load/store work, etc.

The command processor 7000 may receive the control signal and transmit the control signal to the at least one neural processor 1000 through the control channel 6200. Each control signal may be stored as each task in the neural processor 1000.

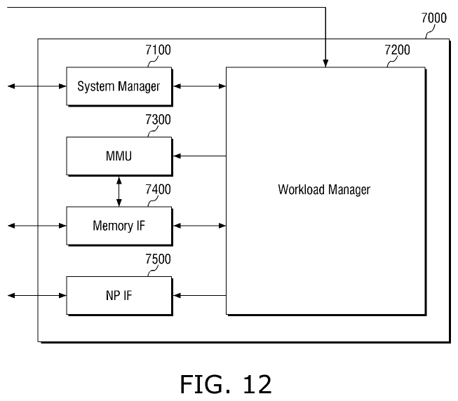

FIG. 12 is a block diagram provided to explain the command processor of FIG. 11 in detail.

Referring to FIG. 12, the command processor 7000 may include a system manager 7100, a workload manager 7200, a memory management unit (MMU) 7300, a memory interface 7400, and a neural processor interface 7500. The system manager 7100, the workload manager 7200, the MMU 7300, the memory interface 7400, and the neural processor interface 7500 may also be called a system manager circuit, a workload manager circuit, an MMU circuit, a memory interface circuit, and a neural processor interface circuit, but will be uniformly referred to as the system manager, the workload manager, the MMU, the memory interface, and the neural processor interface herein for convenience of description. Further, the system manager 7100, the workload manager 7200, the MMU 7300, the memory interface 7400, and the neural processor interface 7500 may each be implemented as a circuit (or circuitry).

The system manager 7100 may manage the interrupt requests transmitted to the host system (HS) and control system details such as the clock, power, or the like of the command processor 7000. The system manager 7100 may exchange data related to the interrupt requests with the workload manager 7200.

The workload manager 7200 may receive and analyze the workload data from the host system (HS). The workload manager 7200 may analyze the workload data and divide it on the basis of command and task units. The workload manager 7200 may generate a task descriptor according to the workload data and transmit the generated task descriptor to the memory interface 7400 and the neural processor interface 7500.

The MMU 7300 may perform management of the memory where data generated by the workload manager 7200 is stored. The MMU 7300 may perform update of the TLB, and perform allocation of memory and management of addresses.

The memory interface 7400 may transmit or receive data to or from the memory through control of the MMU 7300. The memory may refer to the memory of the first neural processing device 10. For example, the memory may include at least one of the off-chip memory 30 of the first neural processing device 1 and the shared memory 2000 of the neural core SoC 10. In some examples, address information on the parameter area (pr), the input data area (IpD), and the neural core data area (NCD) corresponding to the first workload data may also be stored in the memory.

The neural processor interface 7500 may transmit the task descriptor generated by the workload manager 7200 to the neural processor. In addition, each neural processor may transmit a report generated relating to the task to the workload manager 7200.

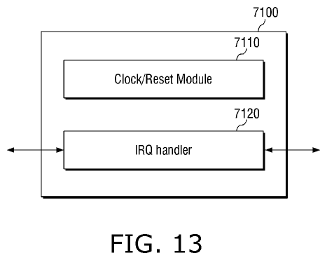

FIG. 13 is a block diagram provided to explain the system manager of FIG. 12 in detail.

Referring to FIG. 13, the system manager 7100 may include a clock/reset module 7110 and an IRQ handler 7120. The clock/reset module 7110 and the IRQ handler 7120 may also be called a clock/reset module circuit and an IRQ handler circuit, respectively, but will be uniformly referred to as the clock/reset module and the IRQ handler herein for convenience of description. Further, the clock/reset module 7110 and the IRQ handler 7120 may be implemented as a circuit (or circuitry).

The clock/reset module 7110 may supply the clock of the command processor 7000 and control the same. Further, the clock/reset module 7110 may provide clock signals of the command processor 7000. Such clock signals may be modulated in each module and used.

The IRQ handler 7120 may control the interrupt request transmitted from the workload manager 7200 to the host system (HS). That is, if the workload manager 7200 needs a response from the host system (HS) during work, or when reporting work result after work, the interrupt request may first be transmitted to the IRQ handler 7120, and the IRQ handler 7120 may report this to the host system (HS).

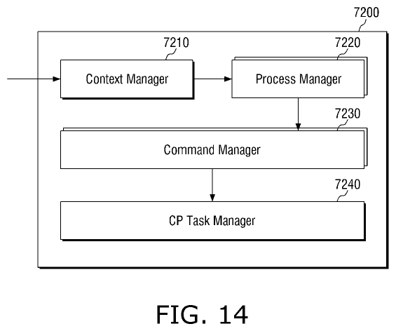

FIG. 14 is a block diagram provided to explain the workload manager of FIG. 12 in detail.

Referring to FIG. 14, the workload manager 7200 may include a context manager 7210, a process manager 7220, a command manager 7230, and a CP task manager 7240. The context manager 7210, the process manager 7220, the command manager 7230, and the CP task manager 7240 may also be called a context manager circuit, a process manager circuit, a command manager circuit, and a CP task manager circuit, respectively, but will be uniformly referred to as the context manager, the process manager, the command manager, and the CP task manager herein for convenience of description. Further, the context manager 7210, the process manager 7220, the command manager 7230, and the CP task manager 7240 may be implemented as a circuit (or circuitry).

The context manager 7210 may read the buffer descriptor and check the context ID. Accordingly, the context manager 7210 may determine to activate the context. The context determined by the context manager 7210 may be transmitted to the process manager 7220.

In some embodiments, a work that should be performed in the neural processing device 1 to achieve a specific purpose may be referred to as the context. The context may include a plurality of commands. In some embodiments, a set of commands to achieve a specific purpose may be referred to as the context. In some embodiments, the command may include a plurality of tasks. In some embodiments, the neural processing device 1 may perform a command by performing a plurality of tasks and may perform a context by performing a plurality of commands.

The process manager 7220 may determine a process to be allocated with the context received from the context manager 7210. Because there may be a plurality of processes for one OS, the process manager 7220 may determine a process corresponding to the current workload. There may be a plurality of process managers 7220. For example, there may be eight process managers 7220, although aspects are not limited thereto. Each process manager 7220 may correspond to a separate process. Accordingly, if there are eight process managers 7220, a total of eight processes may be driven simultaneously.

The command manager 7230 may identify command information such as command stream in the workload data and check dependency between commands. There may be various types of commands. The command manager 7230 may check the dependency between commands and sequentially transmit the commands to the CP task manager 7240. There may be a plurality of command managers 7230. For example, there may be eight command managers 7230, although aspects are not limited thereto. The command managers 7230 may each correspond to a separate process manager 7220. Accordingly, the command manager 7230 may correspond to the process manager 7220 on a 1:1 basis and may be operated per process.

The CP task manager 7240 may receive the command and classify this into task units. The CP task manager 7240 may generate a task descriptor for each task. The task descriptor refers to a transport format to be later transported to each neural processor, and the task descriptor may include control instructions for performing each task. A neural processor that receives the task descriptor may instruct to perform a deep learning work based on the control instruction. Each task may be a computational work or a memory computational work.

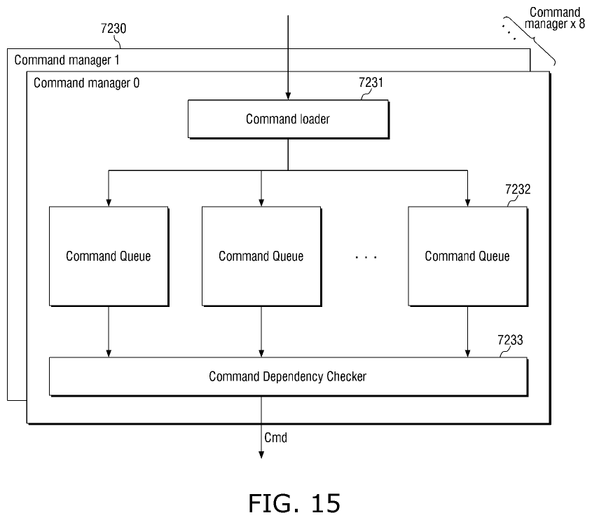

FIG. 15 is a block diagram provided to explain the command manager of FIG. 14 in detail.

Referring to FIG. 15, eight command managers 7230 are illustrated, but aspects are not limited thereto. That is, the number of command managers 7230 may vary.

Each command page may include a command loader 7231, at least one command queue 7232, and a command dependency checker 7233. The command loader 7231, the command queue 7232, and the command dependency checker 7233 may also be called a command loader circuit, a command queue circuit, and a command dependency checker circuit, respectively, but will be uniformly referred to as the command loader, the command queue, and the command dependency checker herein for convenience of description. Further, the command loader 7231, the command queue 7232, and the command dependency checker 7233 may be implemented as a circuit (or circuitry).

The command loader 7231 may load the commands from the workload data received from the process manager 7220. The command loader 7231 may distribute the commands to at least one command queue 7232 according to each command type.

The command queue 7232 may separately receive compute commands for computational works and DMA commands for memory operations. The DMA command may be at least one of hDMA, dDMA, μDMA, and LP μDMA. The hDMA may be a command to access the host off-chip memory (H_OCM), the dDMA may be a command to access the off-chip memory 30, and the μDMA may be a command to access the shared memory 2000, etc. The LP μDMA may be a command with a relatively lower priority among the commands to access the shared memory 2000, etc. That is, the LP μDMA is relatively unimportant command that is performed only when there are no other commands, and may be the command that is previously assigned with a low priority so that relatively more important commands are performed first.

The command dependency checker 7233 may check the dependency of each command and sequentially transmit the commands (Cmd). The command (Cmd) may be transmitted to the CP task manager 7240. The command dependency checker 7233 may not transmit the commands (Cmd) in each command queue 7232 at once, but transmit them sequentially according to the dependency. Accordingly, the sequential execution of the commands (Cmd) according to dependency may be possible.

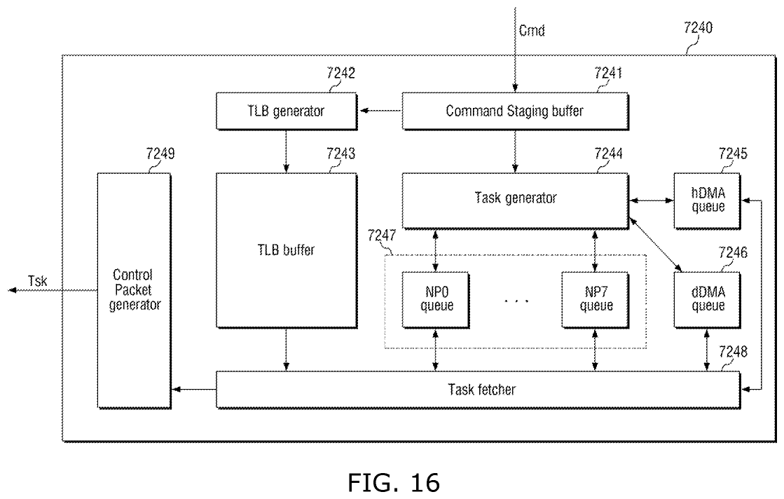

FIG. 16 is a block diagram provided to explain the CP task manager of FIG. 14 in detail.

Referring to FIG. 16, the CP task manager 7240 may include a command staging buffer 7241, a TLB generator 7242, a TLB buffer 7243, a task generator 7244, an hDMA queue 7245, a dDMA queue 7246, a neural processor queue 7247, a task fetcher 7248, and a control packet generator 7249. The command staging buffer 7241, the TLB generator 7242, the TLB buffer 7243, the task generator 7244, the hDMA queue 7245, the dDMA queue 7246, the neural processor queue 7247, the task fetcher 7248 and the control packet generator 7249 may also be called a command staging buffer circuit, a TLB generator circuit, a TLB buffer circuit, a task generator circuit, a hDMA queue circuit, a dDMA queue circuit, a neural processor queue circuit, a task fetcher circuit, and a control packet generator circuit, respectively, but will be uniformly referred to as the command staging buffer, the TLB generator, the TLB buffer, the task generator, the hDMA queue, the dDMA queue, the neural processor queue, the task fetcher, and the control packet generator herein for convenience of description. Further, the command staging buffer 7241, the TLB generator 7242, the TLB buffer 7243, the task generator 7244, the hDMA queue 7245, the dDMA queue 7246, the neural processor queue 7247, the task fetcher 7248, and the control packet generator 7249 may be implemented as a circuit (or circuitry).

The command staging buffer 7241 may receive the command (Cmd) from the command manager 7230. The command staging buffer 7241 may transmit the received command (Cmd) to the TLB generator 7242 and the task generator 7244. The command staging buffer 7241 may receive the commands (Cmd), synchronize them in order, and transmit them again.

The TLB generator 7242 may receive the commands (Cmd) and generate translation index buffer information. The translation index buffer information may be information for translating a virtual address into a physical address. The TLB buffer 7243 may store the translation index buffer information generated by the TLB generator 7242.

The task generator 7244 may receive the command (Cmd) and generate a task (Tsk). The tasks (Tsk) may be generated per type in various ways. For example, the task (Tsk) may include a DMA task and a compute task. The DMA task may include at least one of hDMA for the host off-chip memory (H_OCM) and dDMA for the off-chip memory 30. Such tasks (Tsk) may be transmitted to the hDMA queue 7245 and the dDMA queue 7246, respectively.

The task generator 7244 may distribute and allocate the tasks (Tsk) for the compute tasks of each neural processor. Each task (Tsk) may be transmitted to at least one neural processor queue 7247 so as to be transmitted to at least one neural processor. Although eight neural processor queues 7247 are illustrated in the drawing, aspects are not limited thereto. That is, the number of neural processor queues 7247 may vary.

The task fetcher 7248 may receive the task (Tsk) from the hDMA queue 7245, the dDMA queue 7246, and the neural processor queue 7247 and transmit the received tasks to the control packet generator 7249. The task fetcher 7248 may also receive translation index buffer information from the TLB buffer 7243 and transmit the same to the control packet generator 7249 together with the above information.

The control packet generator 7249 may configure a task descriptor for each task (Tsk) and transmit it to the neural processor or hierarchical memory, etc.

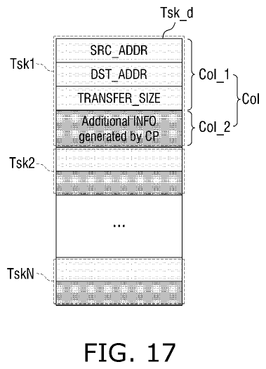

FIG. 17 illustrates an example structure of a task descriptor according to some examples of the present disclosure.

The task descriptor (Tsk_d) may refer to a data structure for describing the task (Tsk) and indicating the attributes of the task. At least one control information field necessary for the operation of the task (Tsk) may be defined, indicating the attributes of the task (Tsk). The task descriptor (Tsk_d) corresponds to a control packet for transmitting the task to the neural processor or hierarchical memory through this control information field. In some examples, the task descriptor may be referred to as a “control command packet.”

The task descriptor (Tsk_d) may be configured to transmit at least one task (Tsk). The control packet generator 7249 may configure the task descriptor (Tsk_d) so that the task descriptor (Tsk_d) includes at least one control information field for the task (Tsk). For example, if there are a plurality of tasks (Tsk), the task descriptor (Tsk_d) may be configured such that it includes at least one control information field corresponding to each task (Tsk). Hereinafter, one control information field or a plurality of control information fields for the task may be referred to as control information.

In some examples, the task descriptor (Tsk_d) may be configured according to the type of task. That is, some task descriptors (Tsk_d) may be the control command packets for transmitting a plurality of compute tasks to designated neural processors. In addition, some task descriptors (Tsk_d) may be the control command packets for transmitting a plurality of DMA tasks to designated memories.

Referring to FIG. 17, the task descriptor (Tsk_d) may be configured such that it includes at least one control information field (Col) corresponding to the first task (Tsk1) to the N-th task (TskN). The at least one control information field may include first control information field (Col_1) and second control information field (Col_2).

The first control information field (Col_1) may include information that instructs the hierarchical memory or neural processor to perform the corresponding task (Tsk). That is, the first control information field (Col_1) may include variable information suitable for the characteristics of the task type of the corresponding task (Tsk). For example, the first task (Tsk1) may have DMA task for the task type, and may include, as the first control information field, variable information such as source address (SRC_ADDR), destination address (DST_ADDR), and transfer size (TRANSFER_SIZE). The hierarchical memory receiving the first task (Tsk1) operates according to this first control information field to perform the first task (Tsk1).

The second control information field (Col_2) may include additional information indicating the characteristics of the corresponding task (Tsk). The second control information field (Col_2) may be information generated by the command processor 7000 for efficient processing of the corresponding task (Tsk). The second control information field (Col_2) may also be configured in the task descriptor and transmitted to the neural processor or hierarchical memory together.

The control packet generator 7249 may configure the task descriptors, and the process of distributing the configured task descriptors may be performed correspondingly to the workload data provided by the host system (HS). That is, if new workload data is received, the command processor 7000 may analyze the workload data and newly configure a corresponding task descriptor. As the control packet generator 7249 repeatedly configures the new task descriptor each time, the overall data processing at the command processor 7000 is increased and efficiency and speed of task distribution are reduced. In addition, because the workload data is repeatedly provided in the similar form due to the nature of the computations processed by the neural processor, configuring a new control command packet having a similar form each time also causes the problem of inefficient use and waste of resources.

The neural processing device 1000 may store previously-generated task descriptors in the memory and selectively reuse necessary information to configure the subsequent task descriptors, thereby saving unnecessary use of resources associated with configuring a new task descriptor each time, and also assisting configuring and distributing task descriptors more efficiently.

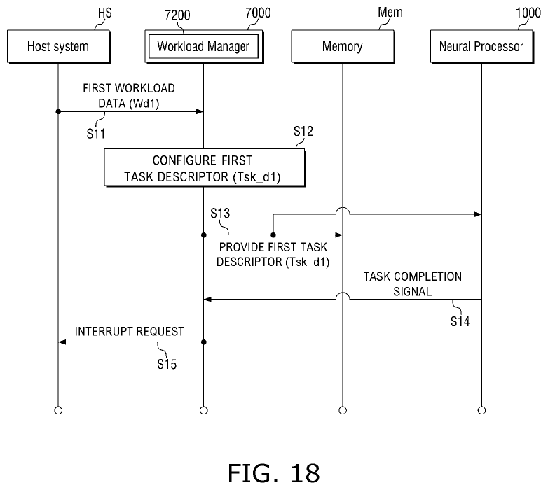

Hereinafter, with reference to FIGS. 18 to 24, the process of configuring a task descriptor, and a configuration related thereto in the neural processing device 1000 according to some examples of the present disclosure will be described in more detail.

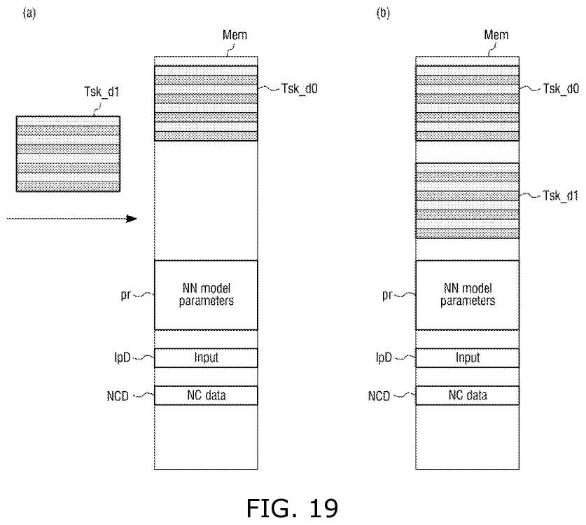

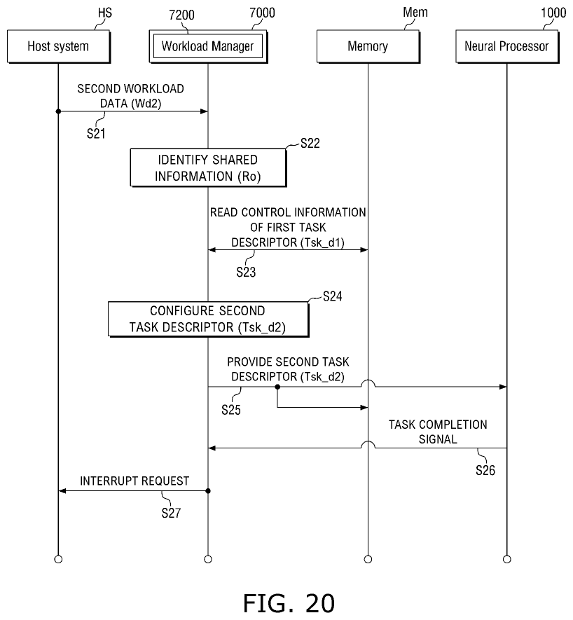

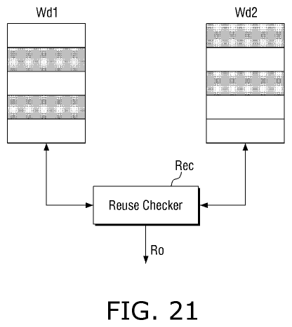

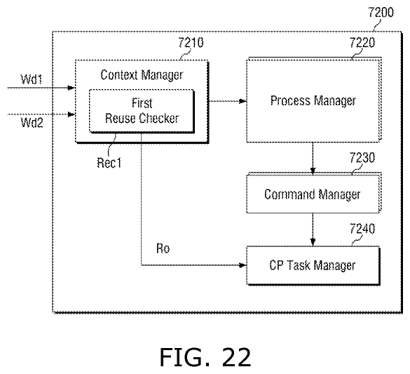

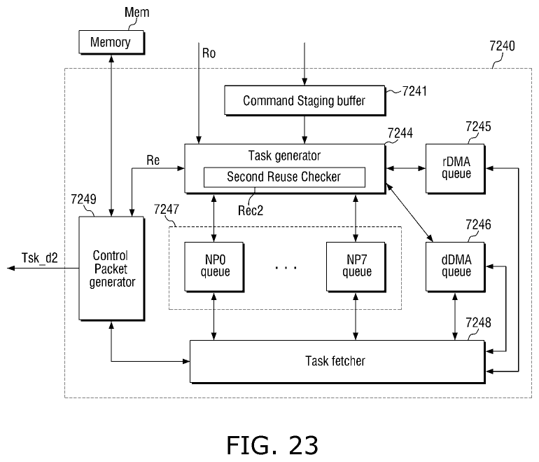

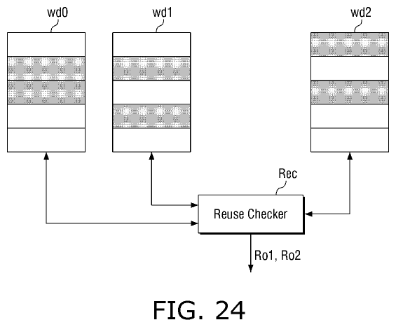

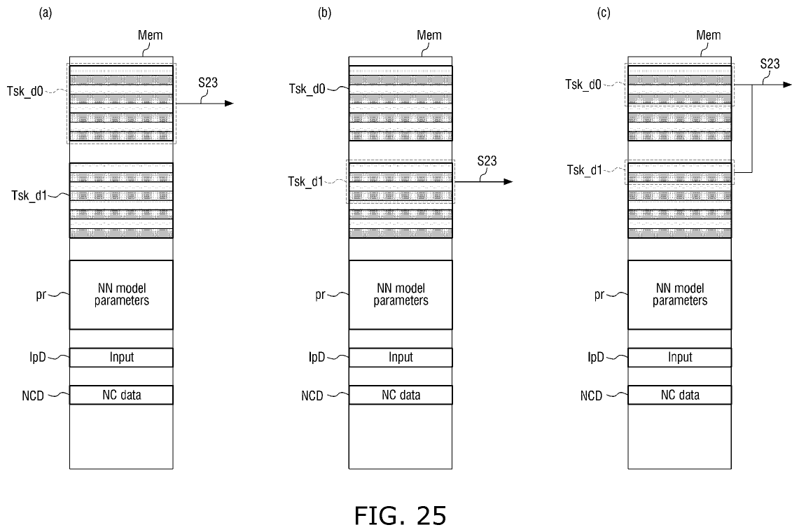

FIG. 18 illustrates sequences for configuring a first task descriptor corresponding to first workload data, in the neural processing device according to some examples of the present disclosure. FIG. 19 is a diagram provided to explain a process of storing a task descriptor in a memory according to some examples of the present disclosure. FIG. 20 illustrates sequences for configuring a second task descriptor corresponding to second workload data, in the neural processing device according to some examples of the present disclosure. FIG. 21 is a diagram provided to explain an operation of a reuse checker according to some examples of the present disclosure. FIG. 22 is a block diagram provided to explain the workload manager according to some examples of the present disclosure. FIGS. 23 and 24 are diagrams provided to explain an example in which the reuse checker is configured in the CP task manager according to some examples of the present disclosure. FIG. 24 is a diagram provided to explain an operation of the reuse checker according to some examples of the present disclosure. FIG. 25 is a diagram provided to explain a process of calling a task descriptor stored in a memory according to some examples of the present disclosure.

Referring to FIG. 18, the workload manager 7200 of the command processor 7000 may receive first workload data (Wd1) from the host system HS, at S11.

At S11, the workload manager 7200 may load a first buffer descriptor according to a first doorbell, access a first command buffer according to the first buffer descriptor, and receive the first workload data (Wd1) from the host off-chip memory (H_OCM). The workload manager 7200 may identify command information in the first workload data (Wd1) and check the dependency between each command. In addition, the workload manager 7200 may divide the commands into task units and define at least one task.

The workload manager 7200 may configure a first task descriptor (Tsk_d1) based on the at least one defined task to transmit the same, at S12.

The at least one identified task may be defined, the control information for performing the task may be generated, and the first task descriptor (Tsk_d1) may be configured. At least one first task descriptor (Tsk_d1) may be configured based on the first workload data (Wd1). That is, if the process of receiving the first workload data (Wd1) is defined as one query, for the task descriptor generated correspondingly to one query, there may be a plurality of task descriptors generated according to the content of the first workload data (Wd1). In some examples, the first workload data (Wd1) may be divided into first to n-th command pages, and first to n-th task descriptors corresponding to the first to n-th command pages may be generated, respectively.

In addition, the first workload data (Wd1) may be analyzed into a plurality of different types of tasks, and the plurality of first task descriptors (Tsk_d1) corresponding to the types of tasks may be configured. For example, the first workload data (Wd1) may be identified as at least one DMA task and at least one compute task, and a task descriptor corresponding to the DMA task and a task descriptor corresponding to the compute task may be configured respectively, so as to configure the first task descriptor (Tsk_d1).

In addition, for the task descriptor generated correspondingly to one query, there may be a plurality of task descriptors generated according to the transmission unit of the packet. The first task descriptor (Tsk_d1) is a control command packet and may be configured into a plurality of divisions corresponding to the size of the packet that can be transmitted from the command processor 7000 to the neural processor 1000.

The workload manager 7200 may provide the configured first task descriptor (Tsk_d1) to the neural processor 1000 at S13. The workload manager 7200 may transmit the first task descriptor (Tsk_d1) to the neural interface 7500. The first task descriptor (Tsk_d1) may be provided to the neural processor 1000 through the neural interface 7500.

The neural processor 1000 may process each task according to the control information included in the transmitted first task descriptor (Tsk_d1), and may transmit a task processing completion signal report to the command processor 7000, at S14. Upon confirming the completion of the task corresponding to the first workload data, the command processor 7000 may transmit an interrupt request (IRQ) to the host system HS, at S15.

In addition, the workload manager 7200 may provide the first task descriptor (Tsk_d1) not only to the neural interface 7500, but also to the memory interface 7400, at S13. The first task descriptor (Tsk_d1) may be provided to the memory (Mem) through the memory interface 7400 and stored in the memory (Mem). The memory (Mem) may refer to at least one of the off-chip memory 30 of the first neural processor device 1 and the shared memory 2000 of the neural core SoC 10.

The first task descriptor (Tsk_d1) is provided to the neural processor 1000 and the memory (Mem). Referring to a part (a) of FIG. 19, the memory (Mem) may include address information on the parameter area (pr), the input data area (IpD), and the neural core data area (NCD) corresponding to the task descriptor (Tsk_d0) stored for the previous query and the first workload data (Wd1) acquired for the current query. The first task descriptor (Tsk_d1) generated correspondingly to the first workload data (Wd1) may be provided to the memory (Mem) and stored as illustrated in a part (b) of FIG. 19. At least one task descriptor may be stored in the memory (Mem).

In some examples, if there are a plurality of first task descriptors, at least one first task descriptor of the plurality of first task descriptors may be stored in the memory (Mem). In addition, in some examples, if the first task descriptor (Tsk_d1) is configured to define a plurality of tasks, the control information related to at least one task, of the control information related to the plurality of tasks, may be stored in the memory (Mem). The task descriptor may be the unit of storage in the memory (Mem), but aspects are not limited thereto, and storage may be performed on the task basis. In this way, the task descriptor (Tsk) stored in the memory (Mem) may be used to configure the task descriptor for the subsequent queries.

Referring to FIG. 20, upon confirming the completion of processing of the first workload data according to the example of FIG. 18, second workload data (Wd2) according to a second doorbell may be provided to the workload manager 7200 of the command processor 7000, at S21.

The second workload data (Wd2) corresponds to subsequent workload data received after the first workload data (Wd1). In some examples, some of the processes for processing the second workload data (Wd2) and the first workload data (Wd1) may be the same. A first context according to the first workload data (Wd1) and a second context according to the second workload data (Wd2) may include at least one piece of shared information. The first workload data may include a plurality of context objects for performing the first context, and the second workload data may include a plurality of context objects for performing the second context. The shared information may refer to a context object included in both the first workload data and the second workload data.

The context object may include an operation code related to the work performed by the neural processor 1000 and variable information applied to the operation. For example, the first context and the second context may include the same operation code as the shared information. That is, the first workload data (Wd1) and the second workload data (Wd2) may perform the same operation, but have different variable information. However, aspects are not limited thereto, and the first context and the second context may have the same operation code and some variable information related to the operation may be the same as each other. That is, both the first workload data (Wd1) and the second workload data (Wd2) may include the operation code and some variable information as the shared information.

The variable information may be a variable that may be different for each context and may be at least one of an input address (Input_ADDR), an input memory (Input_DIM), an output address (Output_ADDR), an output memory (Output_DIM), a stride size (Stride_Size), a loop count A (LOOP_CNT_A), and a loop count B (LOOP_CNT_B).

For example, the first workload data (Wd1) and the second workload data (Wd2) may each include a DMA task, and the destination address corresponding to the DMA task of the second workload data (Wd2) may be the same as the destination address corresponding to the DMA task of the first workload data (Wd1). That is, the destination address may correspond to the shared information. In addition, in some examples, the first workload data (Wd1) and the second workload data (Wd2) may have the same at least one neural processor to which the task is transferred. The first task descriptor configured based on the first workload data (Wd1) and the second task descriptor configured based on the second workload data (Wd2) may be provided to the same neural processor. That is, the first workload data (Wd1) and the second workload data (Wd2) may include, as the shared information, the information on the neural processor to fetch the task.

The workload manager 7200 may configure the second task descriptor in consideration of the shared information.

The workload manager 7200 of the command processor 7000 identifies at least one piece of shared information between the first workload data (Wd1) and the second workload data (Wd2), at S22.

The workload manager 7200 may identify the shared information between the first workload data (Wd1) and the later received the second workload data (Wd2). The workload manager 7200 may include a reuse checker (Rec) that identifies the shared information between the first workload data (Wd1) and the second workload data (Wd2). The reuse checker (Rec) may identify the shared information between the second workload data (Wd2) provided correspondingly to the current query and the first workload data (Wd1) received for the previous query. The reuse checker (Rec) may also be referred to as a reuse checker circuit, but for convenience of description, it is referred to as the reuse checker. In addition, the reuse checker (Rec) may be implemented as a circuit (or circuitry). In addition, in the description described below, the reuse checker (Rec) is illustrated and described as being included in another configuration, but aspects are not limited thereto, and the reuse checker may also be implemented and operated as an independent configuration.

Referring to FIG. 21, the reuse checker (Rec) may analyze the first workload data (Wd1) and the second workload data (Wd2) to identify shared information (Ro). The first workload data (Wd1) may be read from the memory (Mem) for comparison with the second workload data (Wd2). The second workload data may also be stored in the memory (Mem) for a certain period of time for comparison with the workload data provided later.

The reuse checker (Rec) may identify a plurality of context objects to perform the first context for the first workload data (Wd1), and determine whether the second workload data (Wd2) includes the same context objects as the identified context objects of the first workload data (Wd1). The reuse checker (Rec) may identify the context objects included in both the first workload data (Wd1) and the second workload data (Wd2) as the shared information (Ro) and output the shared information (Ro).

In some examples, the reuse checker (Rec) may further receive a second doorbell. The second doorbell may include information on a change in the first doorbell, and may be configured to identify the shared information (Ro) between the second workload data (Wd2) and the previously received first workload data (Wd1) based on the second doorbell. The reuse checker (Rec) may be placed in the workload manager 7200, identify the shared information (Ro), and cause the second task descriptor (Tsk_d2) corresponding to the second workload data (Wd2) to be configured by reusing the first task descriptor (Tsk_d1).

In some examples, the reuse checker (Rec) may include a first reuse checker (Rec1) that identifies the shared information (Ro) shared by the second workload data (Wd2) and the first workload data (Wd1), and a second reuse checker (Rec2) disposed in the CP task manager 7244 to control the generation of tasks and the configuration of the second task descriptor according to the second workload data.

Referring to FIG. 22, the first reuse checker (Rec1) may be configured to be included in the context manager 7210. However, the configuration of the first reuse checker (Rec1) is merely illustrative, and aspects are not limited thereto. That is, the context manager 7210 may identify, through the reuse checker (Rec), the shared information (Ro) shared by the second workload data (Wd2) and the first workload data (Wd1), and transmit the identified shared information (Ro) to the CP task manager 7240. The process manager 7220 may determine a process to be allocated with the second context according to the second workload data (Wd2), the command manager 7230 may identify command information in the second workload data (Wd2), and the process manager 7220 may check the dependency between the commands and sequentially transmit the commands to the CP task manager 7240.

In some examples, the CP task manager 7240 may selectively generate a task according to the shared information (Ro), and may configure the second task descriptor (Tsk_d2) by reading the control information of the first task descriptor (Tsk_d1).

Referring to FIG. 23, the task generator 7244 may include a second reuse checker (Rec2). The second reuse checker (Rec2) may generate call information (Re) based on the shared information (Ro). The call information (Re) may correspond to information on a task of a plurality of tasks of the command, that is not generated according to the shared information.

Specifically, the task generator 7244 may generate at least one task corresponding to a plurality of commands provided by analyzing the second workload data (Wd2), but may not generate a task identified as a shared task by the second reuse checker (Rec2). The second reuse checker (Rec2) may identify whether a plurality of tasks forming a command correspond to the shared information (Ro). In some examples, the type of command may include a DMA type for accessing the memory, and a compute type for computational work, and the second reuse checker may configure the call information for each type of command.

For example, if a plurality of tasks corresponding to a specific command forming the second workload data (Wd2) are defined as the first to n-th tasks (where n is a natural number of 2 or more), and if the tasks identified as the shared tasks based on the shared information (Ro) are the first to fifth tasks, the task generator 7244 may generate only the sixth to n-th tasks.

The task generator 7244 may configure the call information (Re) based on the task information that is not generated according to the shared information (Ro) and the task information configured in the first task descriptor (Tsk_d1), and provide the generated call information (Re) to the control packet generator 7249. In addition, the task generator 7244 may identify, among the tasks related to the second workload data (Wd2), the tasks that do not correspond to the shared information (Ro), configure control information to describe and execute the identified tasks, and output the result to the queue according to each type of task. The task previously generated in relation to the second workload data (Wd2) and stored in the queue may be provided to the control packet generator 7249 through the task fetcher 7248.

The process of identifying the shared information between the workload data described above is not limited to being performed between the current workload data and the immediately preceding workload data. In some examples, the reuse checker (Rec) may further compare the current workload data not only with the immediately previous workload data, but also with the previous workload data before the immediately previous workload data to generate shared information (Ro).

For example, referring to FIG. 24, the memory (Mem) may also include the 0-th workload data (Wd0) received for the previous query before the first workload data (Wd1). The 0-th workload data (Wd0) may be data received for the query immediately preceding the first workload data (Wd1), but is not limited thereto. The task descriptor (Tsk_d0) corresponding to the 0-th workload data (Wd0) may also be stored in the memory (Mem). The reuse checker (Rec) may identify the immediately previous shared information (Ro_1) between the second workload data (Wd2) and the first workload data (Wd1), and identify previous shared information (Ro_2) between the second workload data (Wd2) and the previous workload data (Wd0). That is, the shared information (Ro) may include the first shared information (Ro1) and the second shared information (Ro2). For the second task descriptor (Tsk_d2) corresponding to the second workload data (Wd2), the control information of the first task descriptor (Tsk_d1) may be utilized based on the first shared information (Ro1), and the control information of the 0-th task descriptor (Tsk_d0) may be utilized based on the second shared information (Ro2), respectively.

The control packet generator 7249 may read the control information of the task corresponding to the call information (Re) from the memory (Mem), at S23. Referring to FIG. 25, the control packet generator 7249 may read the control information corresponding to the designated task based on the shared information and configure the second task descriptor based on the read control information. For the task descriptor stored in the memory (Mem), one task descriptor may be read in its entirety or partially read, or information partially read from a plurality of task descriptors may be combined and reused.

In some examples, the shared information may have the same configuration as the task descriptor (Tsk_d0) stored for the previous query, and the stored task descriptor (Tsk_d0) may be read as it is and provided to the control packet generator 7249, as illustrated in FIG. 25A.

In addition, in some examples, the shared information may correspond to certain control information stored in the first task descriptor (Tsk_d1), and as illustrated in of FIG. 25B, the certain control information of the stored first task descriptor (Tsk_d1) may be read and provided to the control packet generator 7249.

In addition, in some examples, the shared information may correspond to certain control information stored in the first task descriptor (Tsk_d1) and certain control information stored in the task descriptor (Tsk_d0), and as illustrated in of FIG. 25C, the certain stored control information of the first task descriptor (Tsk_d1) and the certain stored control information of the task descriptor (Tsk_d0) may be read and provided to the control packet generator 7249.

The control packet generator 7249 may configure the second task descriptor (Tsk_d2) with the control information for defining at least one task generated and transmitted by the task generator 7244, at S24.

The control packet generator 7249 may read at least one piece of control information of the first task descriptor from the memory (Mem) based on the shared information (Ro) provided by the reuse checker (Rec), and configure the second task descriptor (Tsk_d2) by reusing the read control information. That is, the control packet generator 7249 may configure the second task descriptor (Tsk_d2) corresponding to at least one task generated by the task generator 7244, in which the control packet generator 7249 may read at least one piece of control information of the first task descriptor from the memory (Mem) based on the shared information (Ro) provided by the reuse checker (Rec), and reuse the read control information to configure the second task descriptor (Tsk_d2).

In addition, in some examples, if the first workload data (Wd1) and the second workload data (Wd2) include the same task, that is, if the second workload data (Wd2) shares all of the contents of the first workload data (Wd1), the task generator 7244 may not generate a task corresponding to the second workload data (Wd2). That is, the control packet generator 7249 may use the first task descriptor as it is based on the shared information (Ro) to configure the second task descriptor.

The configured second task descriptor may be provided to the memory (Mem) and the neural processor 1000 at S25. The neural processor 1000 may process each task according to the control information included in the transmitted second task descriptor and transmit a task processing completion report to the command processor 7000, at S26. Upon confirming the completion of the task corresponding to the second workload data, the command processor 7000 may transmit an interrupt request (IRQ) to the host system HS, at S27.

The command processor and the neural processing device according to some examples of the present disclosure may store previously-generated task descriptors in the memory and selectively reuse necessary information to configure the subsequent task descriptors, thereby saving unnecessary use of resources associated with configuring a new task descriptor each time, and also assisting configuring and distributing task descriptors more efficiently.

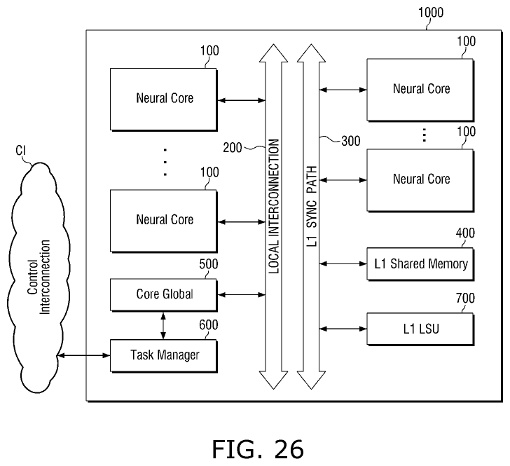

FIG. 26 is a block diagram provided to explain the neural processor of FIG. 11 in detail.

Referring to FIGS. 11 and 26, the neural processor 1000 may include at least one neural core 100, an L1 shared memory 400, an L1 LSU 700, a task manager 600, a core global 500, a local interconnection 200, and an L1 sync path 300. The L1 LSU 700, the task manager 600, and the core global 500 may also be called an L1 LSU circuit, a task manager circuit, and a core global circuit, respectively, but will be uniformly referred to as an L1 LSU, a task manager, and a core global herein for convenience of description. Further, the L1 LSU 700, the task manager 600, and the core global 500 may be implemented as a circuit (or circuitry).

At least one neural core 100 may divide and perform the work of the neural processor 1000. For example, there may be eight neural cores 100. However, aspects are not limited to the above. Although it is shown in FIG. 26 that several neural cores 100 are included in the neural processor 1000, aspects are not limited to the above. That is, the neural processor 1000 may be configured with only one neural core 100.

The neural core 100 may receive task information from the core global 500 and perform a task according to the task information. The task may be defined by the control signals, and the task may be either a compute operation or a memory operation. The memory operation may be, for example, any one of micro DMA (μDMA), LP micro DMA (low priority μDMA), store μDMA (STμDMA), and pre-processing works.

The L1 shared memory 400 may be a memory shared by each neural core 100 in the neural processor 1000. The L1 shared memory 400 may store data of each neural core 100. In addition, the L1 shared memory 400 may receive data from the shared memory 2000 of FIG. 4, temporarily store the data, and transmit the data to each neural core 100. Conversely, the L1 shared memory 400 may receive data from the neural core 100, temporarily store the data, and transfer the data to the shared memory 2000 of FIG. 3.

The L1 shared memory 400 may be a memory corresponding to the neural processor level, that is, to level 1 (L1). The L2 shared memory, that is, the shared memory 2000 may be shared by the neural processor 1000, and the L1 shared memory 400 may be shared by the neural core 100.

The L1 LSU 700 may receive at least one of data, control signals, and synchronization signals from the outside through the global interconnection 6000. The L1 LSU 700 may transmit at least one of the data, the control signals, and the synchronization signals received by the L1 shared memory 400. Similarly, the L1 LSU 700 may transmit at least one of the data, the control signals, and the synchronization signals to the outside through the global interconnection 6000. Further, for each of the neural cores 100, the L1 LSU 700 may transmit and receive at least one of the data, the control signals, and the synchronization signals.

The neural core 100 may receive task information from the core global 500 and perform a task according to the task information. The task may be a work related to the computational work or the memory operation. The task may be defined by the control signals. The task information is information on the task, and it may be information on type of task, form of task, additional information on task, etc.

The neural core 100 may transmit a completion signal indicating completion of the task to the core global 500.

The task manager 600 may receive a task from the control interconnection (CI). The control interconnection (CI) may be a general term for the transmission interfaces that transmit the tasks from the command processor 7000. That is, the control interconnection (CI) may include the control channel 6200 and the local interconnection 200.

The task manager 600 may receive a task, generate task information, and transmit the result to the core global 500. Further, the task manager 600 may receive a completion signal through the core global 500, accordingly generate a completion report, and transmit the result to the command processor 7000 through the control interconnection (CI).

The core global 500 may be a wire structure connected in hardware within the neural core 100. Although not illustrated, the core global 500 may be a structure that connects the neural core 100, the L1 shared memory 400, the L1 LSU 700, and the task manager 600. Accordingly, the local interconnection 200 and the L1 sync path 300 may also be included in the core global 500. However, aspects are not limited to the above.

The core global 500 may receive the task information from the task manager 600, transmit the same to the neural core 100, and receive a corresponding completion signal from the neural core 100. The core global 500 may transmit the completion signal to the task manager 600.

The local interconnection 200 may connect at least one neural core 100, the L1 shared memory 400, the L1 LSU 700, the core global 500, and the task manager 600 to one another. The local interconnection 200 may be a path through which data moves between at least one neural core 100, the L1 shared memory 400, the L1 LSU 700, the core global 500, and the task manager 600. The local interconnection 200 may be connected to the global interconnection 6000 of FIG. 3 to transmit the data.

The L1 sync path 300 may connect at least one neural core 100, the L1 shared memory 400, the L1 LSU 700, the core global 500, and the task manager 600 to one another. The L1 sync path 300 may be a path through which the synchronization signals of at least one neural core 100, the L1 shared memory 400, the L1 LSU 700, the core global 500, and the task manager 600 move.

The L1 sync path 300 may be physically separated from the local interconnection 200. Unlike the global interconnection 6000, the local interconnection 200 may not have sufficient channels formed therein. In this case, the L1 sync path 300 may be formed separately such that it is possible to perform transfer of the synchronization signal quickly and without delay. The L1 sync path 300 may be used for synchronization performed at a level that is one level lower than the L2 sync channel 6300 of the global interconnection 6000.

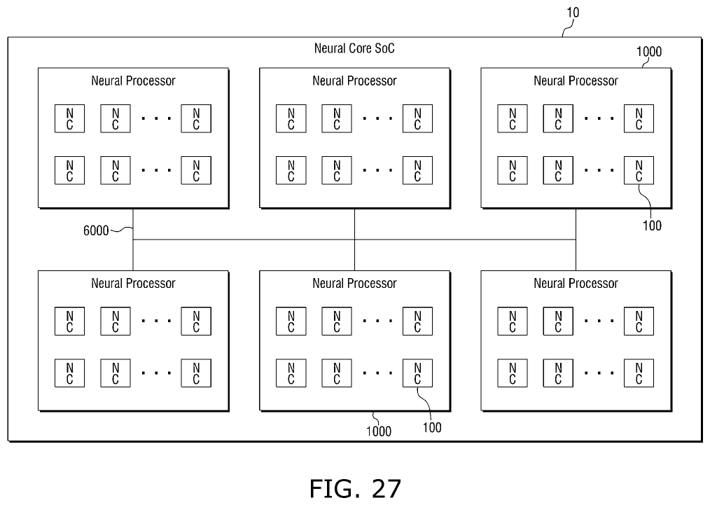

FIG. 27 is a diagram provided to explain a hierarchical structure of the neural processing device according to some examples of the present disclosure.

Referring to FIG. 27, the neural core SoC 10 may include at least one neural processor 1000. Each neural processor 1000 may transmit data to each other through the global interconnection 6000.

Each neural processor 1000 may include at least one neural core 100. The neural core 100 may be a processing unit optimized for deep learning computational works. The neural core 100 may be a processing unit corresponding to one operation of the deep learning computational work. That is, the deep learning computational work may be expressed as a sequential or parallel combination of several operations. The neural core 100 is a processing unit that may each process one operation, and may be the minimum unit of computation that can be considered for scheduling from a compiler's perspective.

The neural processing device may achieve fast and efficient scheduling and performance of computational works by configuring the minimum unit of computations considered for scheduling from the compiler's perspective and the hardware processing unit on the same scale.

That is, if the hardware processing unit that may be divided is too large compared to the computational work, inefficiency in the computational work may occur when operating the processing unit. Conversely, it is not appropriate to always schedule the processing unit smaller than the operation, which is the compiler's minimum scheduling unit, as this may result in scheduling inefficiencies and also increase hardware design costs.

Therefore, the scale of the compiler's scheduling unit and the hardware processing unit may be similarly adjusted to satisfy both the fast computational work scheduling and the efficient computational work performance without wasting hardware resources.

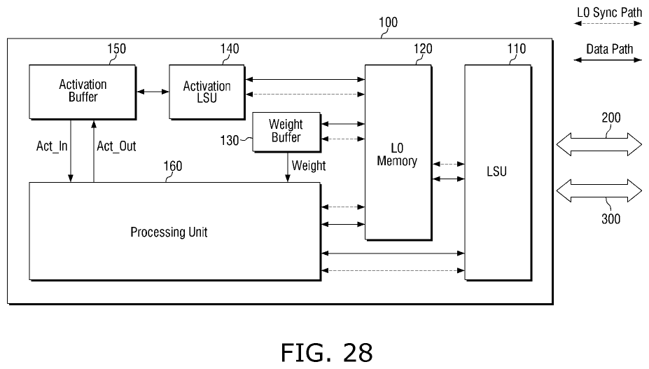

FIG. 28 is a block diagram provided to explain the neural core of FIG. 26 in detail.

Referring to FIG. 28, the neural core 100 may include a load/store unit (LSU) 110, an L0 memory 120, a weight buffer 130, an activation LSU 140, an activation buffer 150, and a processing unit 160. The LSU 110 and the activation LSU 140 may also be called an LSU circuit and an activation LSU circuit, respectively, but will be uniformly referred to as the LSU and the activation LSU herein for convenience of description. Further, the LSU 110 and the activation LSU 140 may be implemented as a circuit (or circuitry).

The LSU 110 may receive at least one of data, control signals, and synchronization signals from the outside through the local interconnection 200 and the L1 sync path 300. The LSU 110 may transmit at least one of the data, the control signals, and the synchronization signals received by the L0 memory 120. Similarly, the LSU 110 may transmit at least one of the data, the control signals, and the synchronization signals to the outside through the local interconnection 200 and the L1 sync path 300.

Specifically, a micro DMA work may be a work of the neural core 100 loading program or data from the shared memory 2000 or the off-chip memory 30 to the L0 memory 120. Unlike the typical micro DMA work, the LP micro DMA work may be a work of loading program or data to be used later, rather than the current program or data. Because these works have a low priority, they may be identified differently from the micro DMA works. An ST Micro DMA work may be a store work of storing the data from the L0 memory 120 of the neural core 100 to the shared memory 2000 or the off-chip memory 30. A pre-processing work may include a work of pre-loading data such as a large amount of lookup tables from the host processor (H_pr).

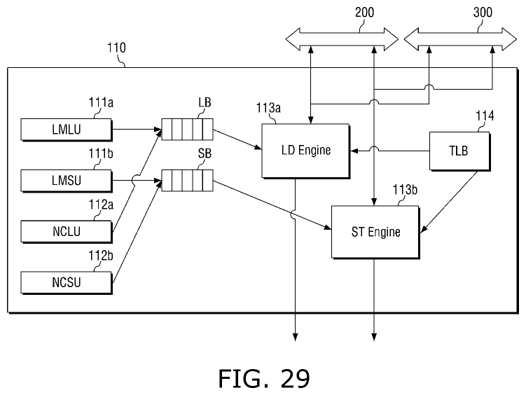

FIG. 29 is a block diagram provided to explain the LSU of FIG. 28 in detail.

Referring to FIG. 29, the LSU 110 includes a local memory load unit 111a, a local memory store unit 111b, a neural core load unit 112a, a neural core store unit 112b, a load buffer (LB), and a store buffer (SB), a load engine 113a, a store engine 113b, and a translation index buffer 114. The local memory load unit 111a, the local memory store unit 111b, the neural core load unit 112a, the neural core store unit 112b, the load engine 113a, and the store engine 113b may also be called a local memory unit circuit, a local memory store unit circuit, a neural core load unit circuit, a neural core store unit circuit, a load engine circuit, and a store engine circuit, but will be uniformly referred to as the local memory load unit, the local memory store unit, the neural core load unit, the neural core store unit, the load engine, and the store engine herein for convenience of description. Further, the local memory load unit 111a, the local memory store unit 111b, the neural core load unit 112a, the neural core store unit 112b, the load engine 113a, and the store engine 113b may be implemented as a circuit (or circuitry).

The local memory load unit 111a may fetch a load instruction for the L0 memory 120 and issue the load instruction. If the local memory load unit 111a provides the issued load instruction to the load buffer (LB), the load buffer (LB) may send the memory access requests to the load engine 113a in order of input.

Further, the local memory store unit 111b may fetch a store instruction for the L0 memory 120 and issue the store instruction. If the local memory store unit 111b provides the issued store instruction to the store buffer (SB), the store buffer (SB) may send the memory access requests to the store engine 113b in order of input.

The neural core load unit 112a may fetch a load instruction for the neural core 100 and issue the load instruction. If the neural core load unit 112a provides the issued load instruction to the load buffer (LB), the load buffer (LB) may send the memory access requests to the load engine 113a in order of input.

Further, the neural core store unit 112b may fetch a store instruction for the neural core 100 and issue the store instruction. If the neural core store unit 112b provides the issued store instruction to the store buffer (SB), the store buffer SB may send the memory access requests to the store engine 113b in order of input.

The load engine 113a may receive the memory access request and call up the data through the local interconnection 200. The load engine 113a may quickly find the data using the translation table of the recently used logical addresses and physical addresses in the translation index buffer 114. If the logical address of the load engine 113a is not in the translation index buffer 114, the address translation information may be found in another memory.

The store engine 113b may receive the memory access request and call up the data through the local interconnection 200. The store engine 113b may quickly find the data using the translation table of the recently used logical addresses and physical addresses in the translation index buffer 114. If the logical address of the store engine 113b is not in the translation index buffer 114, the address translation information may be found in another memory.

The load engine 113a and the store engine 113b may send a synchronization signal to the L1 sync path 300. The synchronization signal may indicate that the work is completed.

Referring to FIG. 28, the L0 memory 120 may be a memory located within the neural core 100, and allow the neural core 100 to receive all of input data required for the work from the outside and temporarily store the data. Further, the L0 memory 120 may temporarily store output data computed by the neural core 100 so as to transmit the same to the outside.

The L0 memory 120 may, by the activation LSU 140, transmit input activation (Act_In) to the activation buffer 150 and receive output activation (Act_Out). Other than the activation LSU 140, the L0 memory 120 may directly transmit and receive data to and from the processing unit 160. That is, the L0 memory 120 may exchange data with each of the PE array 163 and the vector unit 164. The L0 memory 120 may be a memory corresponding to the neural core level. The L0 memory 120 may be a private memory of the neural core.

The L0 memory 120 may transmit data such as activation or weight through a data path. The L0 memory 120 may transmit and receive synchronization signals through an L0 sync path which is a separate private path. For example, the L0 memory 120 may exchange the synchronization signals with the LSU 110, the weight buffer 130, the activation LSU 140, and the processing unit 160, through the L0 sync path.

The weight buffer 130 may receive weight from the L0 memory 120. The weight buffer 130 may transmit the weight to the processing unit 160. The weight buffer 130 may temporarily store the weight before transmitting the same.

The input activation (Act_In) and the output activation (Act_Out) may refer to input value and output value of the layer of the neural network. If the neural network has a plurality of layers, the output value of the previous layer becomes the input value of the next layer, and therefore, the output activation (Act_Out) of the previous layer may be used as the input activation (Act_In) of the next layer.

The weight may refer to a parameter multiplied by the input activation (Act_In) which is input from each layer. The weight is adjusted and confirmed in the deep learning stage, and may be used to derive the output activation (Act_Out) through a fixed value in the inference stage.

The activation LSU 140 may transmit the input activation (Act_In) from the L0 memory 120 to the activation buffer 150 and transmit the output activation (Act_Out) from the activation buffer 150 to the on-chip buffer. That is, the activation LSU 140 may perform both load and store works of the activation.

The activation buffer 150 may provide the input activation (Act_In) to the processing unit 160 and receive the output activation (Act_Out) from the processing unit 160. The activation buffer 150 may temporarily store the input activation (Act_In) and the output activation (Act_Out).

The activation buffer 150 may quickly provide the activation to the processing unit 160 with a large computation load, in particular, to the PE array 163, and quickly receive the activation so as to increase the computing speed of the neural core 100.

The processing unit 160 may be a module that performs computations. The processing unit 160 may perform not only one-dimensional computations but also two-dimensional matrix computations, that is, convolution computations. The processing unit 160 may receive the input activation (Act_In), multiply it by the weight, and add the result to generate the output activation (Act_Out).

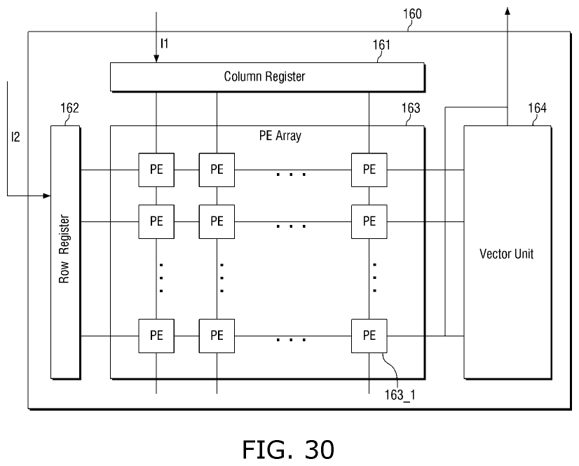

FIG. 30 is a block diagram provided to explain the processing unit of FIG. 28 in detail.

Referring to FIGS. 28 and 30, the processing unit 160 may include a PE array 163, a vector unit 164, a column register 161, and a row register 162.

The PE array 163 may receive the input activation (Act_In) and the weight (Weight) and perform multiplication. The input activation (Act_In) and the weight (Weight) may each be computed through convolution in matrix form. Through this, the PE array 163 may generate the output activation (Act_Out). However, aspects are not limited to the above. The PE array 163 may generate any type of output other than the output activation (Act_Out).

The PE array 163 may include at least one processing element 163_1. The processing elements 163_1 may be aligned with one another and perform multiplication of one input activation (Act_In) and one weight (Weight), respectively.

The PE array 163 may generate a subtotal of the resultant values of each multiplication. The partial sum may be used as the output activation (Act_Out). The PE array 163 may also be called a two-dimensional matrix computing unit as it performs two-dimensional matrix multiplication.

The vector unit 164 may perform one-dimensional computation. The vector unit 164 may perform deep learning computation with the PE array 163. Through this, the processing unit 160 may be specialized for necessary computations. That is, the neural core 100 may include computation modules to perform a large amount of two-dimensional matrix multiplications and one-dimensional computations, and thus be able to perform the deep learning computation efficiently.

The column register 161 may receive a first input (11). The column register 161 may receive the first input (11), divide it, and provide the result to each column of the PE array 163.

The row register 162 may receive a second input (12). The row register 162 may receive the second input 12, divide the same, and provide the result to each row of the PE array 163.

The first input (11) may be the input activation (Act_In) or the weight (Weight). The second input (12) may be either the input activation (Act_In) or the weight (Weight), which is not the first input (11). Alternatively, the first input (11) and the second input (12) may be values other than the input activation (Act_In) and the weight (Weight).

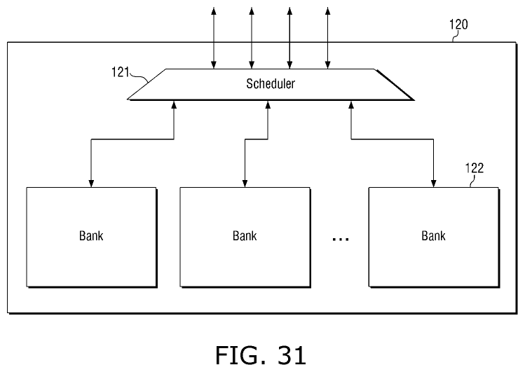

FIG. 31 is a block diagram provided to explain the L0 memory of FIG. 28 in detail.

Referring to FIG. 31, the L0 memory 120 may include a scheduler 121 and at least one local memory bank 122.

When data is stored in the L0 memory 120, the scheduler 121 may receive the data from the load engine 113a. The data may be allocated to the local memory bank 122 in a round robin manner. Accordingly, the data may be stored in any one of at least one local memory bank 122.

Conversely, when the data is loaded from the L0 memory 120, the scheduler 121 may receive the data from the local memory bank 122 and transmit the same to the store engine 113b. The store engine 113b may store the data to the outside through the local interconnection 200.

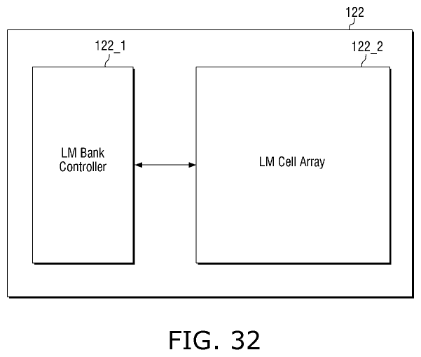

FIG. 32 is a block diagram provided to explain the local memory bank of FIG. 31 in detail.

Referring to FIG. 32, the local memory bank 122 may include a local memory bank controller 122_1 and a local memory bank cell array 122_2.

The local memory bank controller 122_1 may manage read and write operations through address of data stored in the local memory bank 122. That is, the local memory bank controller 122_1 may manage the overall data input and output.

The local memory bank cell array 122_2 may have a structure in which cells directly stored with data are aligned in rows and columns. The local memory bank cell array 122_2 may be controlled by the local memory bank controller 122_1.

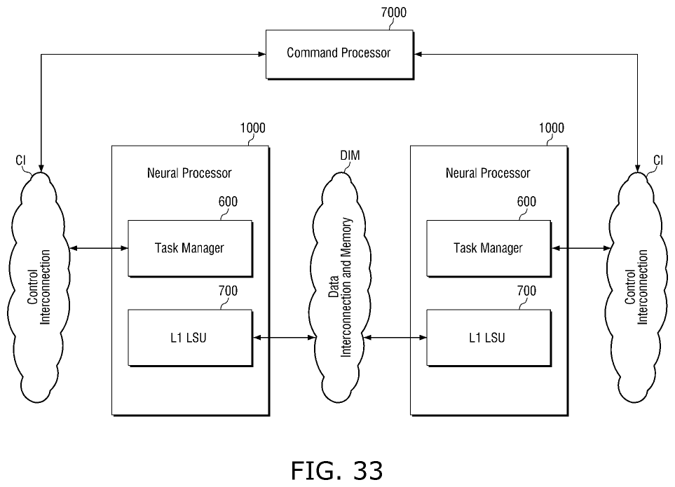

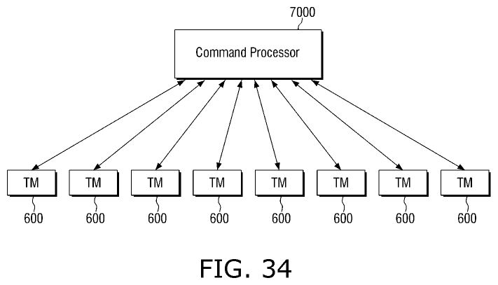

FIG. 33 is a block diagram provided to explain the flow of data and control signals of the neural processing device of FIG. 1, and FIG. 34 is a block diagram provided to explain the relations between the command processor and the task manager of FIG. 33.

Referring to FIGS. 33 and 34, each neural processor 1000 may include the task manager 600 and the L1 LSU 700 therein, respectively. The task managers 600 may exchange control signals and responses with the command processor 7000 through the control interconnection (CI).

Conversely, the L1 LSU 700 may exchange data through the data interconnection and the memory (DIM). The data interconnection and the memory (DIM) may include an interconnection for transmitting data, and a memory for sharing the data. Specifically, the data interconnection and the memory (DIM) may include the local interconnection 200 and the data channel 6100. Further, the data interconnection and the memory (DIM) may include the L1 shared memory 400, the shared memory 2000, and the volatile memory 32. However, aspects are not limited to the above.

The task manager 600 may be controlled by the command processor 7000. That is, the command processor 7000 may transmit a task to the task manager 600 through the control signals, and the task manager 600 may transmit a task completion report to the command processor 7000. The neural processor 1000 may include at least one task manager 600. Further, if there are a plurality of neural processors 1000, the number of task managers 600 may increase. All of the plurality of task managers 600 may be controlled by the command processor 7000.

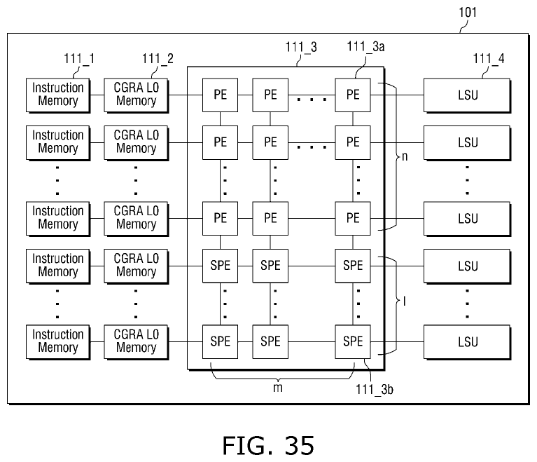

FIG. 35 is a block diagram provided to explain in detail the structure of the neural processing system according to some examples of the present disclosure.

Referring to FIG. 35, unlike the neural core 100, the neural core 101 may have a CGRA structure. The neural core 101 may include an instruction memory 111_1, a CGRA L0 memory 111_2, a PE array 111_3, and a load/store unit (LSU) 111_4.

The instruction memory 111_1 may receive and store instructions. The instruction memory 111_1 may sequentially store the instructions therein and provide the stored instructions to the PE array 111_3. The instruction may instruct the operation of a first type processing element 111_3a included in each PE array 111_3.

The CGRA L0 memory 111_2 may be a memory located within the neural core 101, and the neural core 101 may receive all of input data required for the work from the outside and temporarily store the same in the CGRA L0 memory 111_2. Further, the CGRA L0 memory 111_2 may temporarily store the output data computed by the neural core 101 so as to transmit the same to the outside. The CGRA L0 memory 111_2 may play a role of a cache memory of the neural core 101.

The CGRA L0 memory 111_2 may transmit and receive data to and from the PE array 111_3. The CGRA L0 memory 111_2 may be a memory corresponding to level 0 (L0) lower than L1. The L0 memory may be a private memory of the neural core 101 which is not shared. The CGRA L0 memory (111_2) may transmit data and programs such as activation or weight to the PE array (111_3).

The PE array 111_3 may be a module that performs computation. The PE array 111_3 may perform not only the one-dimensional computation but also the two-, or higher-dimensional matrix/tensor computations. The PE array 111_3 may include a plurality of first type processing elements 111_3a and second type processing elements 111_3b therein.

The first type processing elements 111_3a and the second type processing elements 111_3b may be aligned in rows and columns. The first type processing elements 111_3a and the second type processing elements 111_3b may be aligned in m columns. Further, the first type processing elements 111_3a may be aligned in n rows, and the second type processing elements 111_3b may be aligned in 1 rows. Accordingly, the first type processing elements 111_3a and the second type processing elements 111_3b may be aligned in (n+1) rows and m columns.

The LSU 111_4 may receive at least one of data, control signals, and synchronization signals from the outside through the local interconnection 200. The LSU 111_4 may transmit at least one of the data, the control signals, and the synchronization signals received by the CGRA L0 memory 111_2. Similarly, the LSU 111_4 may transmit at least one of the data, the control signals, and the synchronization signals to the outside through the local interconnection 200.

The neural core 101 may have a Coarse Grained Reconfigurable Architecture (CGRA) structure. Accordingly, for the neural core 101, each of the first type processing elements 111_3a and the second type processing elements 111_3b of the PE array 111_3 may be connected to at least one of the CGRA L0 memory 111_2, the instruction memory 111_1, and the LSU 111_4, respectively. That is, the first type processing element 111_3a and the second type processing element 111_3b may not necessarily be connected to all of the CGRA L0 memories 111_2, the instruction memories 111_1, and the LSUs 111_4, but may be connected to some of them.

Further, the first type processing elements 111_3a and the second type processing elements 111_3b may be different types of processing elements. Accordingly, among the CGRA L0 memory 111_2, the instruction memory 111_1, and the LSU 111_4, the element connected to the first type processing element 111_3a may be different from the element connected to the second type processing element 111_3b.

The neural core 101 with the CGRA structure is capable of high-level parallel computations and direct data exchanges between the first type processing elements 111_3a and the second type processing elements 111_3b, thus greatly saving power consumption. Further, inclusion of two or more types of first type processing elements 111_3a also enable optimization according to various computational works.

For example, if the first type processing element 111_3a is a processing element that performs two-dimensional computation, the second type processing element 111_3b may be a processing element that performs one-dimensional computation. However, aspects are not limited to the above.

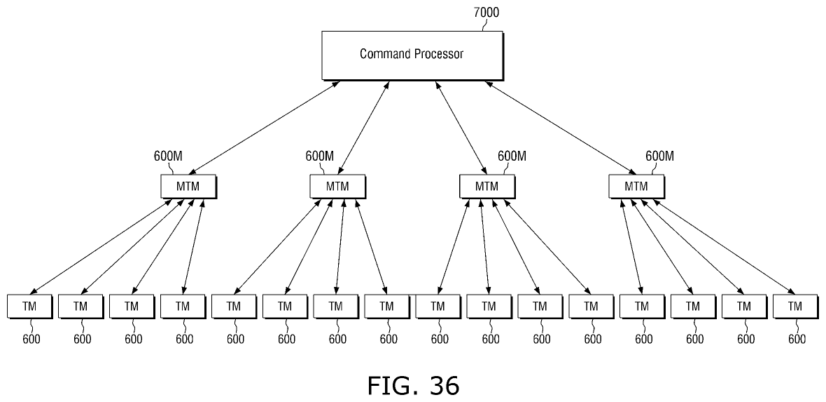

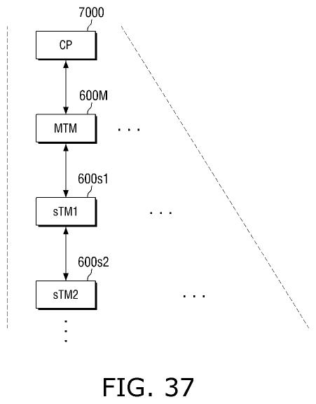

FIG. 36 is a diagram provided to explain the hierarchical structure of the command processor and the task managers of the neural processing device according to some embodiments, and FIG. 37 is a diagram provided to explain the hierarchical structure of the command processor and the task managers of the neural processing device according to some embodiments.

Referring to FIGS. 36 and 37, as the number of task managers 600 increases, it may be difficult for the command processor 7000 to manage all of the task managers 600. Accordingly, the neural processing device 1 according to some examples may have hierarchical structure in which a master task manager 600M manages a plurality of task managers 600, and the command processor 7000 manages the master task manager 600M.

Further, referring to FIG. 37, levels below the master task manager 600M may also be subdivided in various ways. For example, a first sub-task manager 600s1 and a second sub-task manager 600s2 may form respective classes. That is, one first sub-task manager 600s1 may manage at least one second sub-task manager 600s2, and one master task manager 600M may manage at least one first sub-task manager 600s1. Further, several classes may be added below the second sub-task manager 600s2.

That is, although three levels of the task manager 600, the master task manager 600M, and the command processor 7000 are illustrated in FIGS. 36 and 37, the number of levels may be four or more. That is, depth of the hierarchical structure may vary depending on the number of task managers 600.

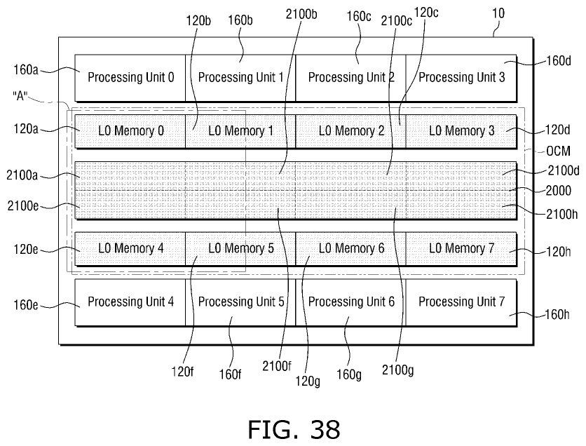

FIG. 38 is a block diagram provided to explain memory reorganization of the neural processing system according to some examples.

Referring to FIG. 38, the neural core SoC 10 may include first to eighth processing units 160a to 160h and an on-chip memory (OCM). Although FIG. 38 illustrates eight processing units as an example, this is only an example and the number of processing units may vary.

The on-chip memory (OCM) may include first to eighth L0 memories 120a to 120h and the shared memory 2000.

The first to eighth L0 memories 120a to 120h may be used as private memories for the first to eighth processing units 160a to 160h, respectively. That is, the first to eighth processing units 160a to 160h and the first to eighth L0 memories 120a to 120h may correspond to each other on a 1:1 basis.

The shared memory 2000 may include first to eighth memory units 2100a to 2100h. The first to eighth memory units 2100a to 2100h may correspond to the first to eighth processing units 160a to 160h and the first to eighth L0 memories 120a to 120h, respectively. That is, the number of memory units may be 8, which is same as the number of processing units and L0 memories.

The shared memory 2000 may operate in any one of two formats of the on-chip memory. That is, the shared memory 2000 may operate in any one of an L0 memory format or a global memory format. The shared memory 2000 may implement two logical memories with one hardware.

If the shared memory 2000 is implemented in the L0 memory format, the shared memory 2000 may operate as a private memory for each of the first to eighth processing units 160a to 160h, such as the first to eighth L0 memories 120a to 120h. The L0 memory may operate at a relatively higher clock speed compared to the global memory, and the shared memory 2000 may also use a relatively faster clock when operating in the L0 memory format.

If the shared memory 2000 is implemented in the global memory format, the shared memory 2000 may operate as a common memory used by both the first processing unit 100a and the second processing unit 100b. The shared memory 2000 may be shared not only by the first to eighth processing units 160a to 160h, but also by the first to eighth L0 memories 120a to 120h.

The global memory may generally use a lower clock than the L0 memory, but aspects are not limited thereto. If the shared memory 2000 operates in the global memory format, the first to eighth processing units 160a to 160h may share the shared memory 2000. In this case, the shared memory 2000 may be connected to the volatile memory 32 of FIG. 2 through the global interconnection 6000, and may operate as a buffer of the volatile memory 32.

At least part of the shared memory 2000 may operate in the L0 memory format, and the remainder of the shared memory may operate in the global memory format. That is, the entire shared memory 2000 may operate in the L0 memory format, or the entire shared memory 2000 may operate in the global memory format. Alternatively, part of the shared memory 2000 may operate in the L0 memory format, and the other of the shared memory may operate in the global memory format.

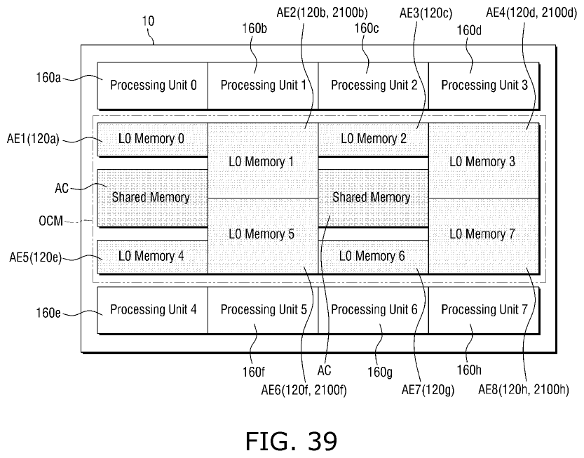

FIG. 39 is a block diagram illustrating an example of memory reorganization of the neural processing system according to some examples of the present disclosure.

Referring to FIGS. 38 and 39, first, third, fifth, and seventh private areas AE1, AE3, AE5, and AE7 of each of the first, third, fifth, and seventh processing units 100a, 100c, 100c, and 100g may include only the first, third, fifth, and seventh L0 memories 120a, 120c, 120c, and 120g. Further, second, fourth, sixth, and eighth private areas AE2, AE4, AE6, and AE8 of each of the second, fourth, sixth, and eighth processing units 100b, 100d, 100f, and 100h may include the second, fourth, sixth, and eighth L0 memories 120b, 120d, 120f, and 120h. Further, the second, fourth, sixth, and eighth private areas AE2, AE4, AE6, and AE8 may include the second, fourth, sixth, and eighth memory units 2100b, 2100d, 2100f, and 2100h. The first, third, fifth, and seventh memory units 2100a, 2100c, 2100c, and 2100g of the shared memory 2000 may be used as a common area (AC).

The common area (AC) may be a memory shared by the first to eighth processing units 160a to 160h. The second private area (AE2) may include the second L0 memory 120b and the second memory unit 2100b. The second private area (AE2) may be an area where the hardware-separated second L0 memory 120b and second memory unit 2100b operate in the same manner so as to logically operate as one L0 memory. Further, the fourth, sixth, and eighth private areas AE4, AE6, and AE8 may operate in the same manner as the second private area (AE2).

The shared memory 2000 may be configured such that the areas corresponding to each neural core may be converted into an optimized ratio of logical L0 memories and logical global memories. The shared memory 2000 may perform adjustment of such ratio at run time.

That is, each neural core may perform the same works, or may perform different works. Accordingly, the capacity of the L0 memories and the capacity of the global memories required for the work performed by each neural core are different each time. Accordingly, if the ratio of the L0 memories and the shared memories is fixed as in the case of the related on-chip memory, inefficiency may occur due to the computational works assigned to each neural core.

Accordingly, the shared memory 2000 of the neural processing device can improve efficiency and speed of computation by setting an optimal ratio of the L0 memories and the global memories depending on the computational work at run time.

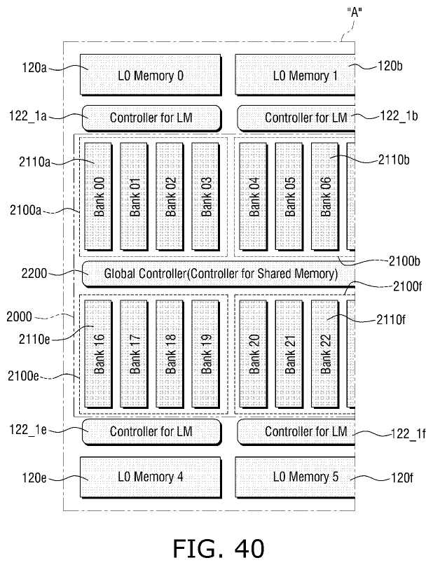

FIG. 40 is an enlarged block diagram of the area A in FIG. 38. Referring to FIGS. 38 and 40, the shared memory 2000 may include a first L0 memory controller 122_1a, a second L0 memory controller 122_1b, a fifth L0 memory controller 122_1e, a sixth L0 memory controller 122_1f, first to eighth memory units 2100a to 2100h, and a global controller 2200. Although not illustrated, the other L0 memory controllers may also be included, but they will not be described herein for convenience of description.

The first L0 memory controller 122_1a may control the first L0 memory 120a. Further, the first L0 memory controller 122_1a may control the first memory unit 2100a. Specifically, if the first memory unit 2100a is implemented in a logical L0 memory format, control by the first L0 memory controller 122_1a may be performed over the first memory unit 2100a.

The second L0 memory controller 122_1b may control the second L0 memory 120b. Further, the second L0 memory controller 122_1b may control the second memory unit 2100b. That is, if the second memory unit 2100b is implemented in the logical L0 memory format, control by the first L0 memory controller 122_1a may be performed over the second memory unit 2100b.

The fifth L0 memory controller 122_1e may control the fifth L0 memory 120e. Further, the fifth L0 memory controller 122_1e may control the fifth memory unit 2100c. That is, if the fifth memory unit 2100e is implemented in the logical L0 memory format, control by the fifth L0 memory controller 122_1e may be performed over the fifth memory unit 2100c.

The sixth L0 memory controller 122_1f may control the sixth L0 memory 120f. Further, the sixth L0 memory controller 122_1f may control the sixth memory unit 2100f. That is, if the sixth memory unit 2100f is implemented in the logical L0 memory format, control by the sixth L0 memory controller 122_1f may be performed over the sixth memory unit 2100f.

The global controller 2200 may control all of the first to eighth memory units 2100a to 2100h. Specifically, if each of the first to eighth memory units 2100a to 2100h logically operates in the global memory format (i.e., not logically operating in the L0 memory format), the global controller 2200 may control the first memory unit 2100a to eighth memory unit 2100h.

That is, each of the first to eighth memory units 2100a to 2100h may be controlled by the first to eighth L0 memory controllers 122_1a to 122_1h, or by the global controller 2200, depending on which of the memory formats they are implemented logically.

If the L0 memory controllers including the first, second, fifth, and sixth L0 memory controllers 122_1a, 122_1b, 122_1c, and 122_1f control the first to eighth memory units 2100a to 2100h, respectively, the first to eighth L0 memory controllers 122_1a to 141h, which control the first to eighth memory units 2100a to 2100h in the same manner as the first to eighth L0 memories 120a to 120h, may control as the private memories of the first to eighth processing units 160a to 160h. Accordingly, the first to eighth memory units 2100a to 2100h may operate at a clock frequency corresponding to the clock frequency of the first to eighth processing units 160a to 160h.

The L0 memory controllers including the first L0 memory controller 122_1a, the second L0 memory controller 122_1b, the fifth L0 memory controller 122_1e, and the sixth L0 memory controller 122_1f may each include the LSU 110 of FIG. 28.

If the global controller 2200 controls at least one of the first to eighth memory units 2100a to 2100h, the global controller 2200 may control each of the first to eighth memory units 2100a to 2100h by the global memory of the first to eighth processing units 160a to 160h. Accordingly, at least one of the first to eighth memory units 2100a to 2100h may operate at a clock frequency not related to the clock frequencies of each of the first to eighth processing units 160a to 160h. However, aspects are not limited to the above.

The global controller 2200 may connect the first to eighth memory units 2100a to 2100h to the global interconnection 6000 of FIG. 3. The first to eighth memory units 2100a to 2100h may exchange data with the off-chip memory 30 of FIG. 2 by the global controller 2200, or exchange data with each of the first to eighth L0 memories 120a to 120h.

The first to eighth memory units 2100a to 2100h may each include at least one memory bank. The first memory unit 2100a may include at least one first memory bank 2110a. The first memory banks 2110a may be the areas of the first memory unit 2100a divided by a specific size. The first memory banks 2110a may all be the memory elements of a same size. However, aspects are not limited to the above. In FIG. 40, it is illustrated that four memory banks are included in one memory unit.

Similarly, the second, fifth, and sixth memory units 2100b, 2100e, and 2100f may include at least one second memory bank 2110b, at least one fifth memory bank 2110e, and at least one sixth memory bank 2110f, respectively.

Hereinbelow, the first memory bank 2110a and the fifth memory bank 2110e will be mainly described, but it is to be noted that the same applies to the other memory banks including the second and sixth memory banks 2110b and 2110f.

The first memory bank 2110a may logically operate in the L0 memory format or logically operate in the global memory format. The first memory bank 2110a may operate independently of the other memory banks in the first memory unit 2100a. However, aspects are not limited to the above.

If each memory bank operates independently, the first memory unit 2100a may include a first area operating in the same manner as the first L0 memory 120a, and a second area operating in a different manner from the first L0 memory 120a. The first area and the second area may not necessarily exist in parallel, and any one area may occupy the entire area of the first memory unit 2100a.

Likewise, the second memory unit 2100b may include a third area operating in the same manner as the second L0 memory 120b, and a fourth area operating in a different manner from the second L0 memory 120b. The third area and the fourth area may not necessarily exist in parallel, and any one area may occupy the entire area of the first memory unit 2100a.

The ratio of the first area and the second area may be different from the ratio of the third area and the fourth area. However, aspects are not limited to the above. Accordingly, the ratio of the first area and the second area may be same as the ratio of the third area and the fourth area. That is, the ratio of the memories configured in each memory unit may vary as desired.

In the related system-on-chip, high-density, low-power SRAM is used for configuring the on-chip memories excluding high-speed L0 memory. This is because SRAM has high efficiency in terms of chip size and power consumption compared to the required capacity. However, inefficiency occurs, because the processing speed of the related on-chip memory will considerably slow down if it is necessary to use the data that exceeds the predetermined capacity of the L0 memory quickly, and besides, there is no way to utilize the remaining global memory even when the need for the global memory is not so large.

Conversely, the shared memory 2000 according to some examples may be selectively controlled by one of the two controllers if necessary. In this case, the shared memory 2000 may not be controlled as a whole by only one of the two controllers, but may be independently controlled on a memory unit basis or a memory bank basis.

Through this, the shared memory 2000 may obtain the optimal ratio of memories according to the computational work during run time, and may thus be able to perform faster and more efficient computational work. For the processing unit specialized for artificial intelligence, different sizes of the L0 memory and global memory may be needed on a specific application basis. Further, even for the same application, if a deep learning network is used, the sizes of the L0 memory and global memory required for each layer may vary. The shared memory 2000 may enable fast and efficient deep learning work because the memory ratio can change during run time according to changes in the computation steps of each layer.

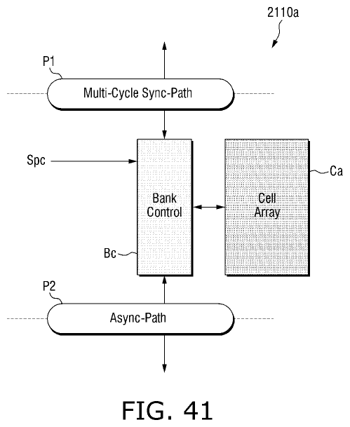

FIG. 41 is a diagram provided to explain the first memory bank of FIG. 40 in detail. Although FIG. 41 illustrates the first memory bank 2110a, the other memory banks may also have the same structure as the first memory bank 2110a.

Referring to FIG. 41, the first memory bank 2110a may include a cell array (Ca), a bank controller (Bc), a first path unit (P1), and a second path unit (P2).

The cell array (Ca) may include a plurality of memory elements (Cells) therein. For the cell array (Ca), a plurality of memory elements may be aligned and disposed in lattice structure. For example, the cell array (Ca) may be a Static Random Access Memory (SRAM) cell array.

The bank controller (Bc) may control the cell array (Ca). The bank controller (Bc) may determine whether the cell array (Ca) is to operate in the L0 memory format or the global memory format, and control the cell array (Ca) accordingly.

Specifically, the bank controller (Bc) may determine during run time whether to transmit and receive data in a direction of the first path unit (P1) or in a direction of the second path unit (P2). The bank controller (Bc) may determine a direction of transmitting and receiving data according to the path control signal (Spc).

The path control signal (Spc) may be generated by a previously designed device driver or compiler. The path control signal (Spc) may be generated according to the features of the computational work. Alternatively, the path control signal (Spc) may be generated by the input received from the user. That is, user may directly apply the input to the path control signal (Spc) in order to select the most optimal memory ratio.

The bank controller (Bc) may determine, through the path control signal (Spc), a path for transmitting and receiving the data stored in the cell array (Ca). The data exchange interface may vary according to the determination of the bank controller (Bc) regarding the path for transmitting and receiving the data. That is, the bank controller (Bc) may use a first interface for exchanging data with the first path unit (P1), and use a second interface for exchanging data with the second path unit (P2). The first interface and the second interface may be different from each other.

Further, an address system for storing the data may vary. That is, if a specific interface is selected, read and write operations may be performed by the corresponding address system.

The bank controller (Bc) may operate at a specific clock frequency. For example, if the cell array (Ca) is an SRAM cell array, the bank controller (Bc) may operate at a general SRAM operating clock frequency.

The first path unit (P1) may be connected to the bank controller (Bc). The first path unit (P1) may directly exchange data of the cell array (Ca) with the first processing unit 100a. By “direct” exchange, it may mean exchange without intervention of the global interconnection 6000. That is, the first processing unit 100a may directly exchange data with the first L0 memory 120a, and the first processing unit 100a may exchange data through the first path unit (P1) when the shared memory 2000 is logically implemented in the L0 memory format. The first path unit (P1) may include the L0 memory controllers including the first L0 memory controller 122_1a and the second L0 memory controller 122_1b of FIG. 30.

The first path unit (P1) may configure a multi-cycle sync path. That is, the operating clock frequency of the first path unit (P1) may be the same as the operating clock frequency of the first processing unit 100a. The first L0 memory 120a may quickly exchange data at the same clock frequency as the operating clock frequency of the first processing unit 100a so as to quickly exchange data with the same speed as that of the operation of the first processing unit 100a. The first path unit (P1) may also operate at the same clock frequency as the operating clock frequency of the first processing unit 100a.

The operating clock frequency of the first path unit (P1) may be a multiple of the operating clock frequency of the bank controller (Bc). In this case, clock domain crossing (CDC) work for clock synchronization between the bank controller (Bc) and the first path unit (P1) is not required, and accordingly, a delay in data transmission may not occur. Accordingly, faster and more efficient data exchange is possible.

In FIG. 41, for example, the operating clock frequency of the first path unit (P1) may be 1.5 GHZ. This may be two times the frequency of 750 MHz of the bank controller (Bc). However, aspects are not limited to the above, and other examples are possible as long as the first path unit (P1) operates at an integer multiple of the clock frequency of the bank controller (Bc).

The second path unit (P2) may be connected to the bank controller (Bc). The second path unit (P2) may exchange data of the cell array (Ca) through the global interconnection 6000 instead of directly exchanging the data with the first processing unit 100a. That is, the first processing unit 100a may exchange the data with the cell array (Ca) through the global interconnection 6000 and the second path unit (P2). The cell array (Ca) may exchange the data with not only the first processing unit 100a but also the other neural cores.

That is, the second path unit (P2) may be a data exchange path between the cell array (Ca) and all of the neural cores, if the first memory bank 2110a is logically implemented in the global memory format. The second path unit (P2) may include the global controller 2200 of FIG. 29.

The second path unit (P2) may configure async-path. The operating clock frequency of the second path unit (P2) may be the same as that of the global interconnection 6000. The second path unit (P2) may also operate at the same clock frequency as the operating clock frequency of the global interconnection 6000.

The operating clock frequency of the second path unit (P2) may not be synchronized with the operating clock frequency of the bank controller (Bc). In this case, a clock domain crossing (CDC) work may be required to synchronize the clocks between the bank controller (Bc) and the second path unit (P2). If the operating clock frequency of the bank controller (Bc) and the operating clock frequency of the second path unit (P2) are not synchronized with each other, the degree of freedom in designing the clock domain may increase. Accordingly, difficulty of hardware design can be lowered and hardware operation may can be derived more easily.

The bank controller (Bc) may use different address systems when exchanging data through the first path unit (P1) and when exchanging data through the second path unit (P2). That is, the bank controller (Bc) may use a first address system through the first path unit (P1) and use a second address system through the second path unit (P2). The first address system and the second address system may be different from each other.

The bank controller (Bc) may not necessarily exist for each memory bank. That is, because the bank controller (Bc) is not a part of scheduling, but plays a role of transmitting signals, it is not an essential part for each memory bank having two ports. Therefore, one bank controller (Bc) may control several memory banks. Even when the bank controller (Bc) controls the several memory banks, the several memory banks may operate independently. However, aspects are not limited to the above.

Of course, the bank controller (Bc) may exist for each memory bank. In this case, the bank controller (Bc) may individually control each memory bank.

Referring to FIGS. 40 and 41, the first memory unit 2100a may use the first address system for exchanging data through the first path unit (P1), and use the second address system for exchanging data through the second path unit (P2). Similarly, the second memory unit 2100b may use the third address system for exchanging data through the first path unit (P1), and use the second address system for exchanging data through the second path unit (P2). The first address system and the third address system may be the same as each other. However, aspects are not limited to the above.

The first address system and the third address system may be used exclusively for the first processing unit 100a and the second processing unit 100b, respectively. The second address system may be commonly applied to the first processing unit 100a and the second processing unit 100b.

In FIG. 41, as an example, the second path unit (P2) may operate at an operating clock frequency of 1 GHz. This frequency may not be synchronized with 750 MHz of the operating clock frequency of the bank controller (Bc). That is, the operating clock frequency of the second path unit (P2) may be freely set and may not be dependent on the operating clock frequency of the bank controller (Bc).

In the general global memory that uses a slow SRAM (e.g., 750 MHZ) with a faster global interconnection (e.g., 1 GHZ), delay inevitably occurs according to CDC work. Conversely, because it is possible that the shared memory 2000 according to some examples uses the first path unit (P1) in addition to the second path unit (P2), delay according to CDC work can be avoided.

Further, because a plurality of neural cores use a single global interconnection 6000 in the general global memory, decrease in overall processing speed easily occurs when data transmission traffics occur simultaneously. Conversely, it is possible that the shared memory 2000 according to some examples uses the first path unit (P1) in addition to the second path unit (P2), thereby providing effects of dispersing the data processing load congesting the global controller 2200.

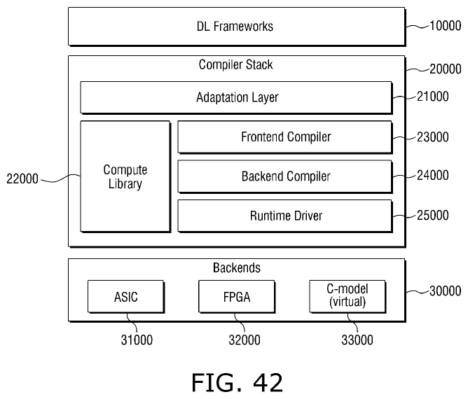

FIG. 42 is a block diagram provided to explain a software hierarchy of a neural processing device.

Referring to FIG. 42, the software layer structure of the neural processing device according to some examples may include a DL framework 10000, a compiler stack 20000, and a backend module 30000.

The DL framework 10000 may refer to a framework for a deep learning model network used by the user. For example, a fully trained neural network may be generated using programs such as TensorFlow or PyTorch.

The compiler stack 20000 may include an adaptation layer 21000, a compute library 22000, a frontend compiler 23000, a backend compiler 24000, and a runtime driver 25000.

The adaptation layer 21000 may be a layer in contact with the DL framework 10000. The adaptation layer 21000 may quantize the user's neural network model generated in the DL framework 10000 and modify the graph. In addition, the adaptation layer 21000 may convert the type of the model into a required type.

The frontend compiler 23000 may convert various neural network models and graphs received from the adaptation layer 21000 into a certain intermediate representation (IR). The converted IR may be a preset expression that is easy to handle later in the backend compiler 24000.

The IR of the frontend compiler 23000 may be optimized in advance at the graph level. In addition, the frontend compiler 23000 may generate the IR by way of conversion into a hardware-optimized layout.

The backend compiler 24000 optimizes the IR converted in the frontend compiler 23000, and converts this into a binary file for use by the runtime driver. The backend compiler 24000 may generate optimized code by dividing the job at a scale that matches the details of the hardware.

Among various operations, the compute library 22000 may store template operations designed in a form suitable for hardware. The compute library 22000 provides the backend compiler 24000 with several template operations that require hardware, thereby generating optimized code.

During operation, the runtime driver 25000 may continuously perform monitoring so as to operate the neural network device according to some examples. Specifically, it may be responsible for executing the interface of the neural network device.

The backend module 30000 may include an application specific integrated circuit (ASIC) 31000, a field programmable gate array (FPGA) 32000, and a C-model 33000. The ASIC 31000 may refer to a hardware chip determined according to a predetermined way of design. The FPGA 32000 may be a programmable hardware chip. The C-model 33000 may refer to a model implemented by simulating hardware on software.

The backend module 30000 may perform various works and derive results using binary code generated through the compiler stack 20000.

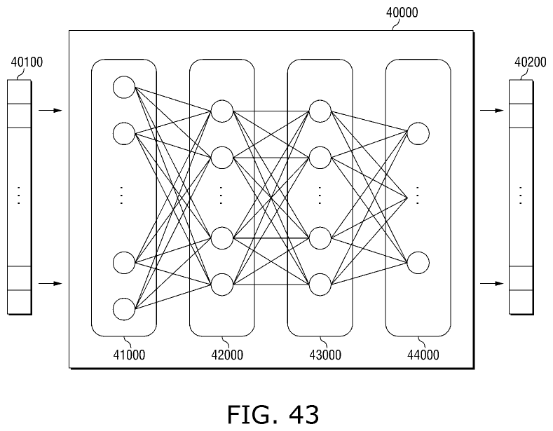

FIG. 43 is a conceptual diagram provided to explain a deep learning computation performed by the neural processing device.

Referring to FIG. 43, in machine learning technology and cognitive science, the artificial neural network model 40000 as an example of the machine learning model refers to a statistical learning algorithm implemented based on a structure of a biological neural network, or to a structure that executes such algorithm.

The artificial neural network model 40000 may represent a machine learning model that acquires a problem solving ability by repeatedly adjusting the weights of synapses by the nodes that are artificial neurons forming the network through synaptic combinations as in the biological neural networks, thus training to reduce errors between a target output corresponding to a specific input and a deduced output. For example, the artificial neural network model 40000 may include any probability model, neural network model, and the like, that is used in artificial intelligence training methods such as machine learning and deep learning.

The neural processing device according to some examples may perform computations by implementing this form of artificial neural network model 40000. For example, the artificial neural network model 40000 may receive an input image and output information on at least a portion of the object included in the input image.

The artificial neural network model 40000 is implemented as a multilayer perceptron (MLP) formed of multiple nodes and connections between them. The artificial neural network model 40000 may be implemented using one of various artificial neural network model structures including the MLP. As illustrated in FIG. 43, the artificial neural network model 40000 includes an input layer 41000 to receive an input signal or data 40100 from the outside, an output layer 44000 to output an output signal or data 40200 corresponding to the input data, and (n) number of hidden layers 42000 to 43000 (where n is a positive integer) positioned between the input layer 41000 and the output layer 44000 to receive a signal from the input layer 41000, extract the features, and transmit the features to the output layer 44000. The output layer 44000 receives signals from the hidden layers 42000 to 43000 and outputs the same to the outside.

The method of training the artificial neural network model 40000 includes the supervised learning that trains to optimize for solving a problem with inputs of teacher signals (correct answers), and the unsupervised learning that does not require a teacher signal.

The neural processing device may directly generate the training data for training the artificial neural network model 40000 through simulation. As described above, the input layer 41000 and the output layer 44000 of the artificial neural network model 40000 are respectively matched with a plurality of output variables corresponding to a plurality of input variables, and as the synaptic values between nodes included in the input layer 41000, the hidden layers 42000 to 43000, and the output layer 44000 are adjusted, training can be processed to extract a correct output corresponding to a specific input. Through this training process, the features hidden in the input variables of the artificial neural network model 40000 may be confirmed, and the synaptic values (or weights) between the nodes of the artificial neural network model 40000 may be adjusted so as to reduce the errors between the output variable calculated based on the input variable and the target output.

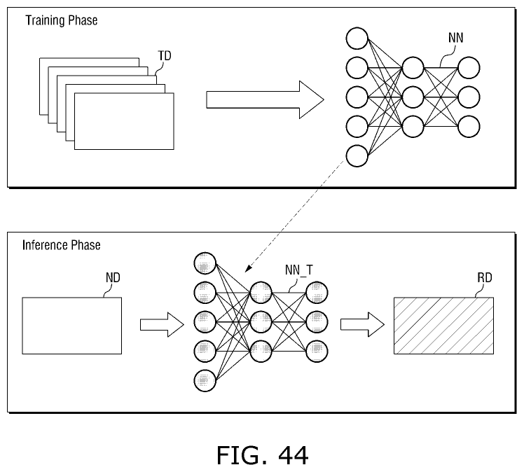

FIG. 44 is a conceptual diagram provided to explain training and inference operations of the neural network of the neural processing device according to some examples of the present disclosure.

Referring to FIG. 44, in the training phase, a plurality of training data (TD) may go through the process of being forwarded to the artificial neural network model (NN) and then backwarded. Through this, the weights and biases of each node of the artificial neural network model (NN) are adjusted, and this allows the model to be trained to produce increasingly accurate results. Through this training phase, the artificial neural network model (NN) may be converted into the trained neural network model (NN_T).

In the inference phase, new data (ND) may be input back to the trained neural network model (NN_T). The trained neural network model (NN_T) may take the new data (ND) as input and derive the result data (RD) through previously trained weights and biases. For this result data (RD), which training materials (TD) are used in the training phase and how many training materials (TD) are used may be important.

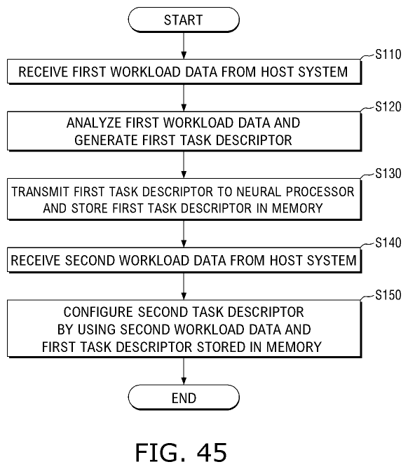

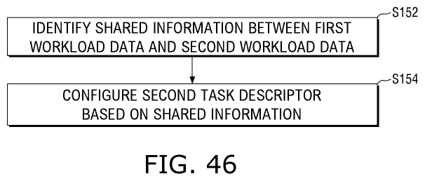

Hereinafter, a task descriptor configuration method of the neural processing device according to some examples of the present disclosure will be described with reference to FIGS. 45 and 46. The task configuration method is performed at the neural processing device 1000 according to FIGS. 1 to 44 described above, and FIGS. 1 to 44 and the related description may be referred to for description of the present example.

FIG. 45 is a flowchart provided to explain the task descriptor configuration method of the neural processing device according to some examples of the present disclosure. FIG. 46 illustrates detailed steps of the second task configuration step in FIG. 45.

Referring to FIG. 45, the task descriptor configuration method of the neural processing device according to some examples of the present disclosure includes receiving first workload data from a host system, at S110, analyzing the first workload data and generating a first task descriptor, at S120, transmitting the first task descriptor to at least one neural processor and storing in a memory, at S130, receiving second workload data from the host system, at S140, and configure the second task descriptor by using the second workload data and at least one piece of control information of the first task descriptor stored in the memory, at S150.

At S110, the workload manager 7200 of the command processor 7000 may receive the first workload data from the host system HS. The workload manager 7200 may identify the command information in the first workload data and check the dependency between each command. In addition, the workload manager 7200 may divide the commands into task units and define at least one task.

At S120, the workload manager 7200 may configure the first task descriptor based on the at least one defined task to transmit the same.

At S130, the workload manager 7200 may provide the first task descriptor not only to the neural interface 7500, but also to the memory interface 7400. The first task descriptor may be provided to the memory (Mem) through the memory interface 7400 and stored in the memory (Mem). The memory (Mem) may refer to at least one of the off-chip memory 30 of the first neural processor device 1 and the shared memory 2000 of the neural core SoC 10. In some examples, if there are a plurality of first task descriptors, at least one first task descriptor of the plurality of first task descriptors may be stored in the memory (Mem). In addition, in some examples, if the first task descriptor (Tsk_1) is configured to define a plurality of tasks, the control information related to at least one task, of the control information related to the plurality of tasks, may be stored in the memory (Mem). The task descriptor may be the unit of storage in the memory (Mem), but aspects are not limited thereto, and storage may be performed on the task basis. In this way, the task descriptor (Tsk) stored in the memory (Mem) may be used to configure the task descriptor for the subsequent queries.

At S140, the workload manager 7200 may receive the second workload data. Upon confirming the completion of processing of the first workload data, the second workload data according to the second doorbell may be provided to the workload manager 7200 of the command processor 7000.

The second workload data corresponds to subsequent workload data received after the first workload data. Some of the processes for processing the second workload data and the first workload data may be the same. The second workload data may include at least one piece of shared information with the first workload data.

At S150, the workload manager 7200 configures a second task descriptor by using the second workload data and at least one piece of control information of the first task descriptor stored in the memory.

Referring to FIG. 46, the operation at S150 may include identifying the shared information between the first workload data and the second workload data, at S152, and configuring the second task descriptor based on the shared information, at S154.

At S152, the workload manager 7200 may identify the shared information between the first workload data (Wd1) and the later received second workload data (Wd2). The workload manager 7200 may include a first reuse checker (Rec1) that identifies the shared information between the first workload data (Wd1) and the second workload data (Wd2). The first reuse checker (Rec1) may identify the shared information between the second workload data (Wd2) provided correspondingly to the current query and the first workload data (Wd1) received for the previous query.

At S152, the first reuse checker (Rec1) may identify a plurality of context objects to perform the first context for the first workload data (Wd1), and determine whether the second workload data (Wd2) includes the same context objects as the identified context objects of the first workload data (Wd1). The first reuse checker (Rec1) may identify the context objects included in both the first workload data (Wd1) and the second workload data (Wd2) as the shared information (Ro) and output the shared information (Ro).

The context object may include an operation code related to the work performed by the neural processor 1000 and variable information applied to the operation. For example, the first context and the second context may include the same operation code as the shared information. That is, the first workload data (Wd1) and the second workload data (Wd2) may perform the same operation, but have different variable information. However, aspects are not limited thereto, and the first context and the second context may have the same operation code and some variable information related to the operation may be the same as each other. That is, both the first workload data (Wd1) and the second workload data (Wd2) may include the operation code and some variable information as the shared information.

The variable information may be a variable that may be different for each context and may be at least one of an input address (Input_ADDR), an input memory (Input_DIM), an output address (Output_ADDR), an output memory (Output_DIM), a stride size (Stride_Size), a loop count A (LOOP_CNT_A), and a loop count B (LOOP_CNT_B).

In addition, the operation at S154 may include generating at least one task based on the second workload data, while excluding a task corresponding to the shared information, and configuring the second task descriptor corresponding to the generated task, in which at least one piece of control information of the first task descriptor is read from the memory based on the call information provided from the second reuse checker, and the second task descriptor is configured by reusing the read control information.

At S154, the task generator 7244 may generate at least one task corresponding to the command according to the second workload data (Wd2), but may not generate a task corresponding to the information included in the shared information (Ro). The second reuse checker (Rec2) may generate the call information (Re) based on the shared information (Ro). The call information (Re) may correspond to information on a task of a plurality of tasks of the command, that is not generated according to the shared information.

The control packet generator 7249 may configure a second task descriptor (Tsk_d2) corresponding to at least one task generated by the task generator 7244, read at least one piece of control information of the first task descriptor from the memory (Mem) based on the call information (Re) provided by the second reuse checker (Rec2), and configure the second task descriptor (Tsk_d2) by reusing the read control information.

The task descriptor configuration method of the neural processing device according to some examples of the present disclosure can store the previously-generated task descriptors in the memory and selectively reuse necessary information to configure the subsequent task descriptors, thereby saving unnecessary use of resources associated with configuring a new task descriptor each time, and also assisting configuring and distributing task descriptors more efficiently.

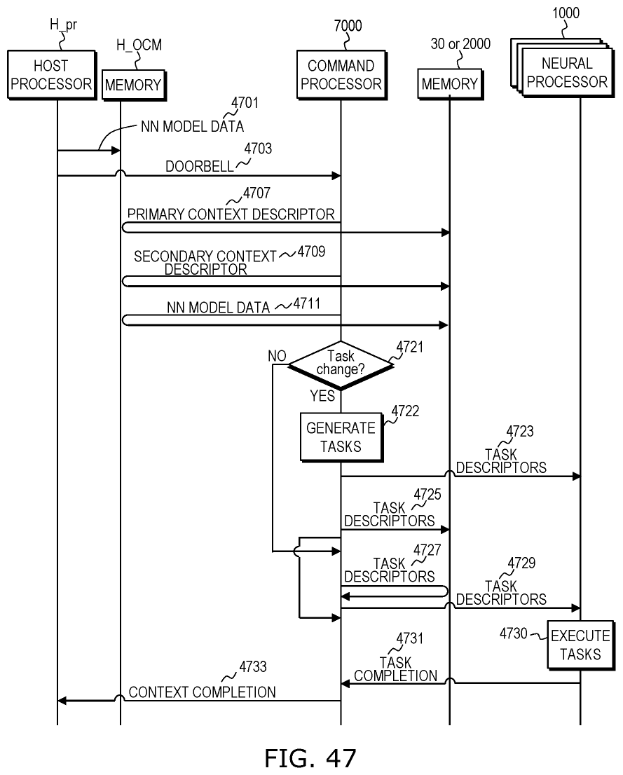

FIG. 47 is a ladder diagram for executing a context of the neural network model according to some examples of the disclosure.

Referring to FIG. 47, the host processor H_pr may create a primary context descriptor, a secondary context descriptor, and a neural network model data for a current context of a neural network model and store them to the host off-chip memory H_OCM at 4701.

In some embodiments, the neural network model data for the current context of the neural network model may comprise parameter data, input data, binary code data, and a command stream. In some embodiments, the parameter data for the neural network model may comprise weights for each of layers for the current context of the neural network model. In some embodiments, the binary code data may contain one or more binary codes using the input data and the parameter data for the current context of the neural network model. In some embodiments, the parameter data for the current context of the neural network model may be the same as or different from the parameter data for the previous context of the neural network model. In some embodiments, the binary code data for the current context of the neural network model may be the same as or different from the binary code data for the previous context of the neural network model.

In some embodiments, the buffer descriptor and the command buffer may be referred to as the primary context descriptor and the second primary context descriptor, respectively.

In some embodiments, the host system may store primary context descriptors in the ring buffer RB.

At 4703, the host processor H_pr may generate a doorbell and transmit the doorbell to the command processor 7000. In some embodiments, a context start signal indicating a start of the current context of the neural network model may be referred to as the doorbell. In some embodiments, the host processor H_pr may write the doorbell to a register which the command processor 7000 monitors as an interrupt. When the command processor 7000 notices that the doorbell has been written in the register, the command processor 7000 may determine that the command processor 7000 receives the doorbell. In some embodiments, the doorbell may comprise or consist of one or more update fields. In some embodiments, each update field of the one or more update fields may include an update index subfield and an update value subfield. In some embodiments, the size of the register the command processor 7000 monitors as an interrupt for the doorbell may be, but not limited to, 32 bits. In some embodiments, the sizes of the update field, the update index subfield, and the update value subfield may be, but not limited to, 32 bits, 8 bits, and 24 bits, respectively. In some embodiments, the update index subfield may indicate an information field to be updated in the primary context descriptor and the secondary context descriptor. In some embodiments, the update value subfield may indicate a value to be updated of the field indicated by the update index subfield. In some embodiments, the doorbell may comprise or consist of a plurality of the updated fields.

The command processor 7000 may directly access the host off-chip memory H_OCM independently of the host processor H_pr according to DMA scheme to read the primary context descriptor from the host off-chip memory H_OCM to store the read primary context descriptor in the off-chip memory 30 or the shared memory 2000, at 4707.

In some embodiments, when the command processor 7000 may manage a register storing a counter indicating how many doorbells are received, the command processor 7000 may determine the address of the primary context descriptor based on the counter indicating the number of received doorbells and may directly access the host off-chip memory H_OCM by using the determined address of the primary context descriptor. For example, the command processor 7000 may reset the counter to 0 and increase the counter by 1 when the command processor 7000 receives one doorbell. In some embodiments, the command processor 7000 may determine the address of the primary context descriptor according to the below Equation 1.

$$[ Equation 1 ]$$

$$( address of primary context descriptor ) = ( the start address of the ring buffer RB ) + [ ( ( value of the counter ) - 1 ) mod ( total number of elements in the ring buffer RB ) ] \times ( the size of an element in the ring buffer RB )$$

In Equation 1, mod represents the modulo operator, and A mod B represents the modulo operation returning the remainder of a division of A by B.

Referring to Equation 1, for example, if the start address of the ring buffer RB is 0x1000, the value of the counter is 4, the total number of elements in the ring buffer RB is 10, and the size of an element in the ring buffer RB is 2 byte, the command processor 7000 may determine the address of the primary context descriptor as 0x1006 which is equal to 0x1000+ ((4−1) mod 10)×2. If the value of the counter is 14, the command processor 7000 may determine the address of the primary context descriptor as 0x1006 which is equal to 0x1000+ ((14−1) mod 10)×2.

In some embodiments, when the doorbell explicitly comprises an index of the doorbell, the command processor 7000 may determine the address of the primary context descriptor based on the index of the received doorbell and may directly access the host off-chip memory H_OCM by using the determined address of the primary context descriptor. For example, the command processor 7000 may determine the address of the primary context descriptor according to the below Equation 2.

$$[ Equation 2 ]$$

$$( address of primary context descriptor ) = ( the start address of the ring buffer RB ) + [ ( ( index ) - 1 ) mod ( total number of elements in the ring buffer RB ) ] \times ( the size of an element in the ring buffer RB )$$

In some embodiments, when the doorbell may explicitly comprise the address of the primary context descriptor, the command processor 7000 may directly access the host off-chip memory H_OCM by using the address of the primary context descriptor in the doorbell.

In some embodiments, the primary context descriptor may comprise one or more information fields. Referring to FIG. 6, the primary context descriptor may comprise a context identifier information field containing an identifier of the current context of the neural network model, a secondary context descriptor address information field containing an address of the secondary context descriptor, and one or more information fields containing binary code for the current context of the neural network model.

The command processor 7000 may directly access the host off-chip memory H_OCM independently of the host processor H_pr according to DMA scheme to read the secondary context descriptor from the host off-chip memory H_OCM to store the read secondary context descriptor in the off-chip memory 30 or the shared memory 2000 at 4709.

In some embodiments, when the primary context descriptor may explicitly comprise the address of the secondary context descriptor, the command processor 7000 may directly access the host off-chip memory H_OCM by using the address of the secondary context descriptor in the primary context descriptor to read the secondary context descriptor.

In some embodiments, when the primary context descriptor may implicitly comprise the address of the secondary context descriptor, the command processor 7000 may determine the address of the secondary context descriptor based on, but not limited to, information in the primary context descriptor and may directly access the host off-chip memory H_OCM by using the address of the secondary context descriptor in the primary context descriptor to read the secondary context descriptor.

In some embodiments, the secondary context descriptor may comprise one or more information fields. Referring to FIG. 7, the secondary context descriptor may comprise a plurality of groups of information fields. Each group of the plurality of groups may be associated with a respective one of a plurality of operations and may comprise one or more information fields. In some embodiments, the secondary context descriptor may comprise a first group of information fields associated with DMA of parameter data for the neural network model, a second group of information fields associated with DMA of input data of the neural network model, a third group of information fields associated with DMA of binary code data for the neural network model, a fourth group of information fields associated with DMA of the command stream for the neural network model, one or more fifth groups of information fields associated with writing a register for the current context of the neural network model, and one or more sixth groups of information fields associated with reading a register for the current context of the neural network model.

In some embodiments, the first group of information fields associated with DMA of parameter data for the neural network model may comprise a source address information field containing a source address pointing to a memory area having the parameter data to be accessed according to DMA scheme, a destination address information field containing a destination address pointing to a memory area in which the accessed parameter data is stored, and a transfer size information field containing a size of the parameter data pointed to by the source address.

In some embodiments, the second group of information fields associated with DMA of input data of the neural network model may comprise a source address information field containing a source address pointing to a memory area having the input data to be accessed according to DMA scheme, a destination address information field containing a destination address pointing to a memory area in which the accessed input data is stored, and a transfer size information field containing a size of the input data pointed to by the source address.

In some embodiments, the third group of information fields associated with DMA of binary code data for the neural network model may comprise a source address information field containing a source address pointing to a memory area having the binary code data to be accessed according to DMA scheme, a destination address information field containing a destination address pointing to a memory area in which the accessed binary code data is stored, and a transfer size information field containing a size of the binary code data pointed to by the source address.

The fourth group of information fields associated with DMA of the command stream for the neural network model may comprise a source address information field containing a source address pointing to a memory area having the command stream to be accessed according to DMA scheme, a destination address information field containing a destination address pointing to a memory area in which the accessed command stream is stored, and a transfer size information field containing a size of the command stream pointed to by the source address.

A respective one fifth group of information fields associated with writing a register for the current context of the neural network model may comprise a register address information field containing a register address pointing to a register in which a value is written for the current context of the neural network model and a register value information field containing a value to be written in the register pointed to by the register address.

A respective one sixth group of information fields associated with reading a register for the current context of the neural network model may comprise a register address information field containing a register address pointing to a register in which a value is read for the current context of the neural network model.

At 4711, the command processor 7000 may directly access the host off-chip memory H_OCM independently of the host processor H_pr according to DMA scheme to read the neural network model data for the current context of the neural network model from the host off-chip memory H_OCM and to store the read neural network model data in the off-chip memory 30 or the shared memory 2000.

In some embodiments, the command processor 7000 may directly access the host off-chip memory H_OCM by using the first group of information fields to read the parameter data for the current context of the neural network model. For example, the command processor 7000 may directly access the host off-chip memory H_OCM by using the source address information field and the transfer size information field of the first group to read the parameter data corresponding to the source address information field and the transfer size information field and to store the read parameter data in a memory area of the off-chip memory 30 or the shared memory 2000 pointed to by the destination address information field of the first group.

In some embodiments, the command processor 7000 may directly access the host off-chip memory H_OCM by using the second group of information fields to read the input data for the current context of the neural network model. For example, the command processor 7000 may directly access the host off-chip memory H_OCM by using the source address information field and the transfer size information field of the second group to read the input data corresponding to the source address information field and the transfer size information field and to store the read input data in a memory area of the off-chip memory 30 or the shared memory 2000 pointed to by the destination address information field of the second group.

In some embodiments, the command processor 7000 may directly access the host off-chip memory H_OCM by using the third group of information fields to read the binary code data for the current context of the neural network model. For example, the command processor 7000 may directly access the host off-chip memory H_OCM by using the source address information field and the transfer size information field of the third group to read the binary code data corresponding to the source address information field and the transfer size information field and to store the read binary code data in a memory area of the off-chip memory 30 or the shared memory 2000 pointed to by the destination address information field of the third group.

In some embodiments, the command processor 7000 may directly access the host off-chip memory H_OCM by using the fourth group of information fields to read the command stream for the current context of the neural network model. For example, the command processor 7000 may directly access the host off-chip memory H_OCM by using the source address information field and the transfer size information field of the fourth group to read the command stream corresponding to the source address information field and the transfer size information field and to store the read command stream in a memory area of the off-chip memory 30 or the shared memory 2000 pointed to by the destination address information field of the fourth group.

In some embodiments, regarding the fifth group of information fields, the command processor 7000 may write a value indicated by the register value information field in the register pointed to by the register address indicated by the register address information field.

In some embodiments, regarding the sixth group of information fields, the command processor 7000 may read a value stored in a register pointed to by the register address indicated by the register value information field.

After the neural network model data for the current context of the neural network model is updated, at 4721, the command processor 7000 may determine whether a plurality of task descriptors for the previous context of the neural network model are allowed to be reused as a plurality of task descriptors for the current context of the neural network model.

In some embodiments, the command processor 7000 may determine whether the plurality of task descriptors for the previous context of the neural network model are allowed to be reused as the plurality of task descriptors for the current context of the neural network model based on the received doorbell.

In some embodiments, the doorbell may explicitly comprise information indicating whether the plurality of task descriptors for the previous context of the neural network model are allowed to be reused as the plurality of task descriptors for the current context of the neural network model. For example, the doorbell may explicitly comprise a flag or information indicating whether the plurality of task descriptors for the previous context of the neural network model are allowed to be reused as the plurality of task descriptors for the current context of the neural network model. In this scenario, the doorbell having the flag or an information field set equal to a first predetermined value may indicate that the plurality of task descriptors for the previous context of the neural network model are allowed to be reused as the plurality of task descriptors for the current context of the neural network model, and the doorbell having the flag or an information field set equal to a second predetermined value may indicate that the plurality of task descriptors for the previous context of the neural network model are not allowed to be reused as the plurality of task descriptors for the current context of the neural network model. For another example, the doorbell having the update index subfield set equal to a predetermined value (for example, but not limited to, 0xFF) may indicate that the plurality of task descriptors for the previous context of the neural network model are allowed to be reused as the plurality of task descriptors for the current context of the neural network model. The doorbell having the update index subfield set equal to a value other than the predetermined value may indicate that the plurality of task descriptors for the previous context of the neural network model are not allowed to be reused as the plurality of task descriptors for the current context of the neural network model.

In some embodiments, the command processor 7000 may determine whether the plurality of task descriptors for the previous context of the neural network model are allowed to be reused as the plurality of task descriptors for the current context of the neural network model based on a location of a register receiving the doorbell. For example, the neural processing device 1 may comprise a first register for receiving the doorbell indicating that the plurality of task descriptors for the previous context of the neural network model are allowed to be reused as the plurality of task descriptors for the current context of the neural network model and a second register for receiving the doorbell indicating that the plurality of task descriptors for the previous context of the neural network model are not allowed to be reused as the plurality of task descriptors for the current context of the neural network model. If the host processor H_pr writes a doorbell in the first register, the command processor 7000 may determine that the plurality of task descriptors for the previous context of the neural network model are allowed to be reused as the plurality of task descriptors for the current context of the neural network model. If the host processor H_pr writes a doorbell in the second register, the command processor 7000 may determine that the plurality of task descriptors for the previous context of the neural network model are not allowed to be reused as the plurality of task descriptors for the current context of the neural network model.

If the command processor 7000 determines that the plurality of task descriptors for the previous context of the neural network model are not allowed to be reused as the plurality of task descriptors for the current context of the neural network model, the command processor 7000 may generate task descriptors based on at least one of the primary context descriptor, the secondary context descriptor, and the neural network model data at 4722 and may distribute the task descriptors to the plurality of neural processors 1000 at 4723 so that the plurality of neural processors 1000 perform tasks described by the task descriptors.

At 4725, the command processor 7000 may store the plurality of task descriptors into the off-chip memory 30 or the shared memory 2000 for future use.

If the command processor 7000 determines that the plurality of task descriptors for the previous context of the neural network model are allowed to be reused as the plurality of task descriptors for the current context of the neural network model, at 4727, the command processor 7000 may read a plurality of task descriptors for the previous context of the neural network model from the off-chip memory 30 or the shared memory 2000.

At 4729, the command processor 7000 may distribute the plurality of task descriptors for the previous context of the neural network model as the plurality of task descriptors for the current context of the neural network model to the plurality of neural processors 1000 so that the plurality of neural processors 1000 perform tasks described by the task descriptors.

After a respective neural processor of the plurality of neural processors 1000 receives a task descriptor, the respective neural processor may execute the task described by the received task descriptor at 4730.

In some embodiments, the respective neural processor may directly access the off-chip memory 30 or the shared memory 2000 according to an address of input data indicated by the task descriptor to read the input data indicated by the task descriptor.

In some embodiments, the respective neural processor may directly access the off-chip memory 30 or the shared memory 2000 according to an address of parameter data indicated by the task descriptor to read the parameter data indicated by the task descriptor.

In some embodiments, the respective neural processor may directly access the off-chip memory 30 or the shared memory 2000 according to an address of binary code data indicated by the task descriptor to read the binary code data indicated by the task descriptor.

In some embodiments, the respective neural processor may execute the binary code data using the input data and the parameter data to generate a task result.

After the plurality of neural processors 1000 complete tasks described by the task descriptors, the command processor 7000 may receive task completion signals from the plurality of neural processors 1000, at 4731.

In some embodiments, the task completion signal from the respective neural processor may include the task result generated by the respective neural processor.

If the command processor 7000 receives task completion signals from the plurality of neural processors 1000, the command processor 7000 may transmit a context completion signal indicating that the current context of the neural network model has been completed, at 4733.

In some embodiment, if the command processor 7000 receives task completion signals for all tasks distributed to the plurality of neural processors 1000 for the current context of the neural network model, the command processor 7000 may transmit a signal indicating that the current context of the neural network model has been completed.

In some embodiments, the context completion signal may include, or be transmitted along with, an operation result of the current context of the neural network model.

In some embodiments, blocks, units, modules, and components as described above may be implemented as a circuit or circuitry. Blocks, units, modules, and components which perform processing may be referred to as a processor, a processing circuit, a processor circuit, or a processing circuitry. Blocks, units, modules, and components which store data may be referred to as a memory, a memory circuit, or a memory circuitry.

Hereinafter, various aspects will be described.

In some aspects, an apparatus comprises: one or more neural processors configured to perform neural network model tasks; a command processor configured to distribute neural network model tasks to the one or more neural processors; and a shared memory shared by the one or more neural processors. The command processor is configured to cause: in response to receiving a context start signal indicating a start of a context of a neural network model from a host system, directly accessing a memory in the host system to read neural network model data for the context of the neural network model; determining whether a plurality of task descriptors for a previous context of the neural network model are allowed to be reused for a plurality of task descriptors for the current context of the neural network model; based on a determination on whether the plurality of task descriptors for the previous context of the neural network model are not allowed to be reused for the plurality of task descriptors for the current context of the neural network model, generating the plurality of task descriptors for the current context of the neural network model; and distributing the plurality of task descriptors for the current context of the neural network model to the one or more neural processors so that the one or more neural processors perform tasks described by the plurality of task descriptors for the current context of the neural network model.

In some aspects, generating the plurality of task descriptors for the current context of the neural network model comprises: based on a determination that the plurality of task descriptors for the previous context of the neural network model are not allowed to be reused for the plurality of task descriptors for the current context of the neural network model, generating the plurality of task descriptors for the current context of the neural network model based on the neural network model data; and based on a determination that the plurality of task descriptors for the previous context of the neural network model are allowed to be reused for the plurality of task descriptors for the current context of the neural network model, reading the plurality of task descriptors for the previous context of the neural network model from the shared memory and generating the plurality of task descriptors for the current context of the neural network model based on the plurality of task descriptors for the previous context of the neural network model.

In some aspects, generating the plurality of task descriptors for the current context of the neural network model based on the neural network model data comprises: storing the plurality of task descriptors for the current context of the neural network model in the shared memory for a next context of the neural network model.

In some aspects, generating the plurality of task descriptors for the current context of the neural network model based on the plurality of task descriptors for the previous context of the neural network model comprises: setting the plurality of task descriptors for the current context of the neural network model equal to the plurality of task descriptors for the previous context of the neural network model.

In some aspects, determining comprises: determining whether the plurality of task descriptors for the previous context of the neural network model are allowed to be reused for the plurality of task descriptors for the current context of the neural network model based on the context start signal.

In some aspects, whether the plurality of task descriptors for the previous context of the neural network model are allowed to be reused for the plurality of task descriptors for the current context of the neural network model is determined based on an indication included in the context start signal.

In some aspects, whether the plurality of task descriptors for the previous context of the neural network model are allowed to be reused for the plurality of task descriptors for the current context of the neural network model is determined based on a location of a register receiving the context start signal.

In some aspects, the command processor is further configured to cause: receiving, from the one or more neural processors, task completion signals indicating completion of tasks described by the plurality of task descriptors for the current context of the neural network model; and transmitting, to the host system, a context completion signal indicating completion of the current context of the neural network model in response to receiving the task completion signals

In some aspects, directly accessing a memory in the host system to read neural network model data for the context of the neural network model comprises: in response to receiving the context start signal, directly accessing the memory in the host system to read the one or more context descriptors; and directly accessing the memory in the host system based on the one or more context descriptors to read the neural network model data.

In some aspects, directly accessing the memory in the host system to read the one or more context descriptors comprises: determining an address of a primary context descriptor based on the context start signal; directly accessing the memory in the host system based on the address of the primary context descriptor to read the primary context descriptor; determining an address of the secondary context descriptor based on the primary context descriptor; and directly accessing the memory in the host system based on the address of the secondary context descriptor to read the secondary context descriptor, and wherein directly accessing the memory in the host system based on the one or more context descriptors to read the neural network model data comprises: directly accessing the memory in the host system based on the secondary context descriptor to read the neural network model data.

In some aspects, directly accessing the memory in the host system based on the secondary context descriptor to read the neural network model data comprises: directly accessing the memory in the host system based on the secondary context descriptor to read parameter data for the neural network model and to store the parameter data into the shared memory; directly accessing the memory in the host system based on the secondary context descriptor to read input data for the neural network model and to store the input data into the shared memory; and directly accessing the memory in the host system based on the secondary context descriptor to read binary code data for the neural network model and to store the binary code data into the shared memory.

In some aspects, a method performed by a command processor configured to distribute neural network model tasks to the one or more neural processors and operably coupled to a shared memory shared by the one or more neural processors, the method comprising: in response to receiving a context start signal indicating a start of a context of a neural network model from a host system, directly accessing a memory in the host system to read neural network model data for the context of the neural network model; determining whether a plurality of task descriptors for a previous context of the neural network model are allowed to be reused for a plurality of task descriptors for the current context of the neural network model; based on a determination on whether the plurality of task descriptors for the previous context of the neural network model are not allowed to be reused for the plurality of task descriptors for the current context of the neural network model, generating the plurality of task descriptors for the current context of the neural network model; and distributing the plurality of task descriptors for the current context of the neural network model to the one or more neural processors so that the one or more neural processors perform tasks described by the plurality of task descriptors for the current context of the neural network model.

In some aspects, generating the plurality of task descriptors for the current context of the neural network model comprises: based on a determination that the plurality of task descriptors for the previous context of the neural network model are not allowed to be reused for the plurality of task descriptors for the current context of the neural network model, generating the plurality of task descriptors for the current context of the neural network model based on the neural network model data; and based on a determination that the plurality of task descriptors for the previous context of the neural network model are allowed to be reused for the plurality of task descriptors for the current context of the neural network model, reading the plurality of task descriptors for the previous context of the neural network model from the shared memory and generating the plurality of task descriptors for the current context of the neural network model based on the plurality of task descriptors for the previous context of the neural network model.

In some aspects, generating the plurality of task descriptors for the current context of the neural network model based on the neural network model data comprises: storing the plurality of task descriptors for the current context of the neural network model in the shared memory for a next context of the neural network model.

In some aspects, generating the plurality of task descriptors for the current context of the neural network model based on the plurality of task descriptors for the previous context of the neural network model comprises: setting the plurality of task descriptors for the current context of the neural network model equal to the plurality of task descriptors for the previous context of the neural network model.

In some aspects, determining comprises: determining whether the plurality of task descriptors for the previous context of the neural network model are allowed to be reused for the plurality of task descriptors for the current context of the neural network model based on the context start signal.

In some aspects, whether the plurality of task descriptors for the previous context of the neural network model are allowed to be reused for the plurality of task descriptors for the current context of the neural network model is determined based on an indication included in the context start signal.

In some aspects, whether the plurality of task descriptors for the previous context of the neural network model are allowed to be reused for the plurality of task descriptors for the current context of the neural network model is determined based on a location of a register receiving the context start signal.

In some aspects, the command processor is further configured to cause: receiving, from the one or more neural processors, task completion signals indicating completion of tasks described by the plurality of task descriptors for the current context of the neural network model; and transmitting, to the host system, a context completion signal indicating completion of the current context of the neural network model in response to receiving the task completion signals

In some aspects, directly accessing a memory in the host system to read neural network model data for the context of the neural network model comprises: in response to receiving the context start signal, directly accessing the memory in the host system to read the one or more context descriptors; and directly accessing the memory in the host system based on the one or more context descriptors to read the neural network model data.

The above description is merely illustrative of the technical idea of the examples, and those of ordinary skill in the art to which the examples pertain will be able to make various modifications and variations without departing from the essential characteristics of the examples. Accordingly, the examples are not intended to limit the technical idea of the examples, but to explain the technical idea, and the scope of the technical idea of the examples is not limited by these examples. The scope of protection of the examples should be interpreted in accordance with the claims below, and all technical ideas within the equivalent scope should be interpreted as being included in the scope of claims of the examples.

1. An apparatus comprising:
one or more neural processors configured to perform neural network model tasks;
a command processor configured to distribute neural network model tasks to the one or more neural processors; and
a shared memory shared by the one or more neural processors,
wherein the command processor is configured to cause:
in response to receiving a context start signal indicating a start of a context of a neural network model from a host system, directly accessing a memory in the host system to read neural network model data for the context of the neural network model;
determining whether a plurality of task descriptors for a previous context of the neural network model are allowed to be reused for a plurality of task descriptors for the current context of the neural network model;
based on a determination on whether the plurality of task descriptors for the previous context of the neural network model are not allowed to be reused for the plurality of task descriptors for the current context of the neural network model, generating the plurality of task descriptors for the current context of the neural network model; and
distributing the plurality of task descriptors for the current context of the neural network model to the one or more neural processors so that the one or more neural processors perform tasks described by the plurality of task descriptors for the current context of the neural network model.

2. The apparatus of claim 1, wherein generating the plurality of task descriptors for the current context of the neural network model comprises:
based on a determination that the plurality of task descriptors for the previous context of the neural network model are not allowed to be reused for the plurality of task descriptors for the current context of the neural network model, generating the plurality of task descriptors for the current context of the neural network model based on the neural network model data; and
based on a determination that the plurality of task descriptors for the previous context of the neural network model are allowed to be reused for the plurality of task descriptors for the current context of the neural network model, reading the plurality of task descriptors for the previous context of the neural network model from the shared memory and generating the plurality of task descriptors for the current context of the neural network model based on the plurality of task descriptors for the previous context of the neural network model.

3. The apparatus of claim 2, wherein generating the plurality of task descriptors for the current context of the neural network model based on the neural network model data comprises:
storing the plurality of task descriptors for the current context of the neural network model in the shared memory for a next context of the neural network model.

4. The apparatus of claim 2, wherein generating the plurality of task descriptors for the current context of the neural network model based on the plurality of task descriptors for the previous context of the neural network model comprises:
setting the plurality of task descriptors for the current context of the neural network model equal to the plurality of task descriptors for the previous context of the neural network model.

5. The apparatus of claim 1, wherein determining comprises:
determining whether the plurality of task descriptors for the previous context of the neural network model are allowed to be reused for the plurality of task descriptors for the current context of the neural network model based on the context start signal.

6. The apparatus of claim 5, wherein whether the plurality of task descriptors for the previous context of the neural network model are allowed to be reused for the plurality of task descriptors for the current context of the neural network model is determined based on an indication included in the context start signal.

7. The apparatus of claim 5, wherein whether the plurality of task descriptors for the previous context of the neural network model are allowed to be reused for the plurality of task descriptors for the current context of the neural network model is determined based on a location of a register receiving the context start signal.

8. The apparatus of claim 1, wherein the command processor is further configured to cause:
receiving, from the one or more neural processors, task completion signals indicating completion of tasks described by the plurality of task descriptors for the current context of the neural network model; and
transmitting, to the host system, a context completion signal indicating completion of the current context of the neural network model in response to receiving the task completion signals.

9. The apparatus of claim 1, wherein directly accessing a memory in the host system to read neural network model data for the context of the neural network model comprises:
in response to receiving the context start signal, directly accessing the memory in the host system to read the one or more context descriptors; and
directly accessing the memory in the host system based on the one or more context descriptors to read the neural network model data.

10. The apparatus of claim 9, wherein directly accessing the memory in the host system to read the one or more context descriptors comprises:
determining an address of a primary context descriptor based on the context start signal;
directly accessing the memory in the host system based on the address of the primary context descriptor to read the primary context descriptor;
determining an address of the secondary context descriptor based on the primary context descriptor; and
directly accessing the memory in the host system based on the address of the secondary context descriptor to read the secondary context descriptor, and
wherein directly accessing the memory in the host system based on the one or more context descriptors to read the neural network model data comprises:
directly accessing the memory in the host system based on the secondary context descriptor to read the neural network model data.

11. The apparatus of claim 10, wherein directly accessing the memory in the host system based on the secondary context descriptor to read the neural network model data comprises:
directly accessing the memory in the host system based on the secondary context descriptor to read parameter data for the neural network model and to store the parameter data into the shared memory;
directly accessing the memory in the host system based on the secondary context descriptor to read input data for the neural network model and to store the input data into the shared memory; and
directly accessing the memory in the host system based on the secondary context descriptor to read binary code data for the neural network model and to store the binary code data into the shared memory.

12. A method performed by a command processor configured to distribute neural network model tasks to the one or more neural processors and operably coupled to a shared memory shared by the one or more neural processors, the method comprising:
in response to receiving a context start signal indicating a start of a context of a neural network model from a host system, directly accessing a memory in the host system to read neural network model data for the context of the neural network model;
determining whether a plurality of task descriptors for a previous context of the neural network model are allowed to be reused for a plurality of task descriptors for the current context of the neural network model;
based on a determination on whether the plurality of task descriptors for the previous context of the neural network model are not allowed to be reused for the plurality of task descriptors for the current context of the neural network model, generating the plurality of task descriptors for the current context of the neural network model; and
distributing the plurality of task descriptors for the current context of the neural network model to the one or more neural processors so that the one or more neural processors perform tasks described by the plurality of task descriptors for the current context of the neural network model.

13. The apparatus of claim 12, wherein generating the plurality of task descriptors for the current context of the neural network model comprises:
based on a determination that the plurality of task descriptors for the previous context of the neural network model are not allowed to be reused for the plurality of task descriptors for the current context of the neural network model, generating the plurality of task descriptors for the current context of the neural network model based on the neural network model data; and
based on a determination that the plurality of task descriptors for the previous context of the neural network model are allowed to be reused for the plurality of task descriptors for the current context of the neural network model, reading the plurality of task descriptors for the previous context of the neural network model from the shared memory and generating the plurality of task descriptors for the current context of the neural network model based on the plurality of task descriptors for the previous context of the neural network model.

14. The apparatus of claim 13, wherein generating the plurality of task descriptors for the current context of the neural network model based on the neural network model data comprises:
storing the plurality of task descriptors for the current context of the neural network model in the shared memory for a next context of the neural network model.

15. The apparatus of claim 13, wherein generating the plurality of task descriptors for the current context of the neural network model based on the plurality of task descriptors for the previous context of the neural network model comprises:
setting the plurality of task descriptors for the current context of the neural network model equal to the plurality of task descriptors for the previous context of the neural network model.

16. The apparatus of claim 12, wherein determining comprises:
determining whether the plurality of task descriptors for the previous context of the neural network model are allowed to be reused for the plurality of task descriptors for the current context of the neural network model based on the context start signal.

17. The apparatus of claim 16, wherein whether the plurality of task descriptors for the previous context of the neural network model are allowed to be reused for the plurality of task descriptors for the current context of the neural network model is determined based on an indication included in the context start signal.

18. The apparatus of claim 16, wherein whether the plurality of task descriptors for the previous context of the neural network model are allowed to be reused for the plurality of task descriptors for the current context of the neural network model is determined based on a location of a register receiving the context start signal.

19. The apparatus of claim 12, wherein the command processor is further configured to cause:
receiving, from the one or more neural processors, task completion signals indicating completion of tasks described by the plurality of task descriptors for the current context of the neural network model; and
transmitting, to the host system, a context completion signal indicating completion of the current context of the neural network model in response to receiving the task completion signals.

20. The apparatus of claim 12, wherein directly accessing a memory in the host system to read neural network model data for the context of the neural network model comprises:
in response to receiving the context start signal, directly accessing the memory in the host system to read the one or more context descriptors; and
directly accessing the memory in the host system based on the one or more context descriptors to read the neural network model data.
